(19) United States
(12) Patent Application Publication
(10) Pub. No.: US 2026/0319125 A1
(43) Pub. Date: Oct. 15, 2026

(54) GENERATION METHOD OF ALL-ZONE APPARENT RESISTIVITY-DEPTH SECTION FOR CSAMT

(71) Applicant: Jiangsu University, Jiangsu (CN)

(72) Inventors: Qinghua CAO, Jiangsu (CN); Shu YAN, Jiangsu (CN)

(73) Assignee: Jiangsu University, Jiangsu (CN)

(21) Appl. No.: 18/880,275

(22) PCT Filed: Dec. 14, 2023
(86) PCT No.: PCT/CN2023/138630

§ 371 Date: Dec. 31, 2024

(30) Foreign Application Priority Data
Aug. 7, 2023 (CN) 202310988624.8

(51) Int. Cl. G01V 3/38; G01V 3/02

(52) U.S. Cl. CPC G01V 3/38; G01V 3/02

(57) ABSTRACT

The present disclosure provides a generation method of an all-zone apparent resistivity-depth section for CSAMT, including: taking a horizontal position

$${P}_{i , j}^{r}$$

and a vertical position

$${P}_{i , j}^{z}$$

of a recording point, where in a far-field zone, the recording point is located at a detection depth under an observation point; in a transition-field zone, a radius of a wavefront decreases linearly with a decrease of an induction number, and the recording point is located at an intersection between the wavefront and a straight line from the detection depth to a source; and in a near-field zone, with the continuous decrease of the induction number, the horizontal position of the recording point approaches from a position adjacent to the source to a midpoint of an offset, and the vertical position of the recording point approaches from a position adjacent to the source to a fixed value proportional to the offset.

### TECHNICAL FIELD

The present disclosure belongs to the field of electromagnetic exploration, and particularly relates to a generation method of an all-zone apparent resistivity-depth section for controlled source audio-frequency magneto-telluric (CSAMT).

### RELATED ART

The common CSAMT exploration usually involves information of a near-field zone, a transition-field zone and a far-field zone (Zonge and Hughes, 1991, p750). From the far-field zone to the near-field zone, as the nonplanewave-to-planewave ratio changes, the recording point under an observation point will move towards the source to cause the source overprint effect and the shadow effect (Zonge and Hughes, 1991, p769-784). This makes the apparent resistivity-depth section interpreted hardly.

For example, Chinese Patent Application CN 113960684 A provides an apparent resistivity-depth section generating method for short-offset electromagnetic exploration. For a zone from the observation point to the midpoint of the offset, an algorithm in which the recording point moves with the induction number is provided, thereby widening the application scope of the apparent resistivity-depth section interpretation method. However, this method neglects a zone from the midpoint of the offset to the source, and cannot cope with the source overprint effect and the shadow effect from the source to the midpoint of the offset.

### SUMMARY OF INVENTION

In view of shortages in the prior art, the present disclosure provides a generation method of an all-zone apparent resistivity-depth section for CSAMT. By moving the recording point from the observation point to a position adjacent to the source, and using an all-zone expression of a field (Spies and Frischknecht, 1991, p294) to generate the all-zone apparent resistivity-depth section, the present disclosure eliminates and utilizes the source overprint effect and the shadow effect, provides a novel simple and quick method for separation of planewave and nonplanewave, thereby improving the interpretation accuracy of the apparent resistivity-depth section.

The present disclosure adopts the following technical solutions:

A generation method of an all-zone apparent resistivity-depth section for CSAMT includes: taking a horizontal position

$${P}_{i , j}^{r}$$

and a vertical position

$${P}_{i , j}^{z}$$

of a recording point as an assignment point for an apparent resistivity, where in a far-field zone, the recording point is located at a detection depth under an observation point; in a transition-field zone, a radius of a wavefront decreases linearly with a decrease of an induction number, and the recording point is located at an intersection between the wavefront and a straight line from the detection depth to a source, and approaches to the source from the observation point with the decrease of the induction number; and in a near-field zone, with a continuous decrease of the induction number, the horizontal position of the recording point approaches from a position adjacent to the source to a midpoint of an offset, and the vertical position of the recording point approaches from a position adjacent to the source to a fixed value:

$$\begin{matrix}{P}_{i , j}^{r} = {r}_{i} \\ {P}_{i , j}^{z} = - {δ}_{i , j}^{FD}\end{matrix} \} , {B}_{i , j} \geq {cri}^{far - tran} \qquad ( 1 a )$$

$$\begin{matrix}{P}_{i , j}^{r} = \frac{{B}_{i , j}}{\sqrt{{B}_{i , j}^{2} + 1}} \frac{{r}_{i}}{{cri}^{far - tran} - {cri}^{tran - near}} ( {B}_{i , j} - {cri}^{tran - near} ) \\ {P}_{i , j}^{z} = \frac{1}{\sqrt{{B}_{i , j}^{2} + 1}} \frac{{r}_{i}}{{cri}^{far - tran} - {cri}^{tran - near}} ( {B}_{i , j} - {cri}^{tran - near} )\end{matrix} \} , {cri}^{tran - near} < {B}_{i , j} < {cri}^{far - tran} \qquad ( 1 b )$$

$$\begin{matrix}{P}_{i , j}^{r} = \frac{{r}_{i}}{2} ( \frac{c r {i}^{tran - near} - {B}_{i , j}}{c r {i}^{t ran - near}} ) \\ {P}_{i , j}^{Z} = \frac{{r}_{i}}{c r {i}^{far - tran}} ( \frac{c r {i}^{tran - near} - {B}_{i , j}}{c r {i}^{tran - near}} )\end{matrix} \} , 0 < {B}_{i , j} < c r {i}^{t r a n - near} \qquad ( 1 c )$$

where,

$${B}_{i , j} = \frac{{r}_{i}}{{δ}_{i , j}^{FD}}$$

is the induction number, rᵢ is an offset,

$${δ}_{i , j}^{FD}$$

is the detection depth, i=1, 2, . . . , m is a serial number of the observation point, j=1, 2, . . . , n is a serial number of a frequency, cri^{far-tran} is a critical value between the far-field zone and the transition-field zone, and cri^{tran-near} is a critical value between the transition-field zone and the near-field zone;
(1) for an axial configuration, assuming that the source coincides with an origin O of a rectangular coordinate system, and a survey line is arranged along an x-axis, if a superscript r of

$${P}_{i , j}^{r}$$

in each of the Equation (1a), the Equation (1b), and the Equation (1c) is replaced with x, then on an xOz plane along the survey line, the recording point for the observation point has the horizontal position labeled as

$${P}_{i , j}^{x} ,$$

and the vertical position labeled as

$${P}_{i , j}^{z} ,$$

and a
position of the recording point is the assignment point for the apparent resistivity

$${ρ}_{i , j}^{a}$$

of each observation point of the axial configuration on the xOz plane; and one survey line of the axial configuration generates one apparent resistivity-depth section along the survey line;
(2) for an equatorial configuration, one equatorial configuration having m observation points generates one section along a survey line, and m sections from the source to the observation points; assuming that a midpoint of the survey line serves an origin O′, the source coincides with an origin O of a cylindrical coordinate system, a connecting line OO′ is perpendicular to the survey line, and the survey line is arranged along an x′-axis of a rectangular coordinate system, if the superscript r of the

$${P}_{i , j}^{r}$$

in the Equation (1a) is replaced with x′, then on an x′O′z plane along the survey line, the recording point for the observation point has the horizontal position labeled as

$${P}_{i , j}^{{x}^{′}} ,$$

and the vertical position labeled as

$${P}_{i , j}^{z} ,$$

and a position of the recording point is the assignment point for the apparent resistivity

$${ρ}_{i , j}^{a}$$

of each observation point of the equatorial configuration on the x′O′z plane; and
on each rOz plane where each section from the source to the observation point is located, the horizontal position

$${P}_{i , j}^{r}$$

and the vertical position

$${P}_{i , j}^{z}$$

of the recording point for the observation point are still as shown in the Equation (1a), the Equation (1b), and the Equation (1c); and a position of the recording point is the assignment point for the apparent resistivity

$${ρ}_{i , j}^{a}$$

of the observation point of the equatorial configuration rOz plane.

Further, the fixed value is proportional to the offset; and the fixed value is obtained by dividing the offset rᵢ by the critical value cri^{far-tran} between the far-field zone and the transition-field zone.

Further, a relationship between the offset rᵢ and the position

$${x}_{i}^{′}$$

of the observation point in the equatorial configuration is expressed as:

$${r}_{i} = \sqrt{{OO}^{′2} + {x}_{i}^{′2}} \qquad ( 2 )$$

where, the survey line is arranged along the x′-axis of the rectangular coordinate system, the midpoint of the survey line serves as the origin O′, the source coincides with the origin O of the cylindrical coordinate system, the connecting line is OO′, and

$${x}_{i}^{′}$$

is a value of the observation point on the x′-axis.

Further, the apparent resistivity

$${ρ}_{i , j}^{a}$$

is defined and calculated from an all-zone expression of a single-component electric field or a single-component magnetic field; and the all-zone expression of the electric field component

$${E}_{i , j}^{x}$$

and the simple iterative expression for an all-zone apparent resistivity are:

$${E}_{i , j}^{x} = \frac{{I}_{j} l {ρ}_{i , j}^{a}}{4 π {r}_{i}^{3}} [ 2 {e}^{- {jk}_{i , j} {r}_{i}} ( 1 + j {k}_{i , j} {r}_{i} ) + 3 cos 2 {φ}_{i} - 1 ] \qquad ( 3 a )$$

$${ρ}_{i , j}^{a} = \frac{4 π {r}_{i}^{3}}{{I}_{j} l} \vert \frac{{E}_{i , j}^{x}}{2 {e}^{{J}^{{k}_{i , j} {r}_{i}}} ( 1 + j {k}_{i , j} {r}_{i} ) + 3 cos 2 {φ}_{i} - 1} \vert \qquad ( 3 b )$$

the all-zone expression of the electric field component

$${E}_{i , j}^{y}$$

and the direct calculation expression for an all-zone apparent resistivity are:

$${E}_{i \cdot j}^{y} = \frac{3 {I}_{j} l {ρ}_{i , j}^{a}}{4 π {r}_{i}^{3}} sin 2 {φ}_{i} \qquad ( 4 a )$$

$${ρ}_{i , j}^{a} = \frac{4 π {r}_{i}^{3}}{3 {I}_{j} l} \vert \frac{{E}_{i \cdot j}^{y}}{sin 2 {φ}_{i}} \vert \qquad ( 4 b )$$

where, Iⱼ is a source current intensity of a j th frequency, l is a length of the source, j is an imaginary unit, φᵢ is an included angle between the observation point i and the source, and

$${k}_{i , j} = \frac{2 π}{1 {0}^{3}} \sqrt{- j \frac{{f}_{i , j}}{{ρ}_{i , j}^{a}} / 5} ,$$

f_{i,j} being the j th frequency of the observation point i, and μ₀ being a permeability of a nonmagnetic earth.

Further, the detection depth

$${δ}_{i , j}^{FD}$$

is calculated by a skin depth equation:

$${δ}_{i , j}^{FD} \approx 503 \sqrt{\frac{{ρ}_{i , j}^{a}}{{f}_{i , j}}} \qquad ( 5 )$$

where, f_{i,j} is a j th frequency of an observation point i, and

$${ρ}_{i , j}^{a}$$

is an apparent resistivity of the j th frequency of the observation point i.

Further, the offset is at least cri^{far-tran} times a total thickness of a detection stratum.

Further, for the axial configuration, the critical value of the field zone cri^{far-tran} and the critical value of the field zone cri^{tran-near} are respectively selected as 5 and 1.

Further, for the equatorial configuration, the critical value of the field zone cri^{far-tran} and the critical value of the field zone cri^{tran-near} are respectively selected as 4 and 1.

Further, the critical value of the field zone cri^{far-tran} and the critical value of the field zone cri^{tran-near} are adjusted according to geological structure, configuration, source, or observation component.

Further, field observation records further include a position of the source besides the position of the observation point and a scale of the source, to determine the offset.

### Advantages

1) The apparent resistivity-depth section generated by the method of the present disclosure is applicable to all zones in the CSAMT exploration.

2) The present disclosure provides a novel simple and quick method for separating the planewave and the nonplanewave in the CSAMT exploration.

3) The present disclosure expands the range of movement of the recording point from the observation point to the source, and provides a novel simple and quick method to eliminate and utilize the source overprint effect and the shadow effect in the CSAMT exploration, thereby improving the interpretation accuracy of the apparent resistivity-depth section.

### BRIEF DESCRIPTION OF DRAWINGS

FIG. 1 illustrates that a recording point of a single observation point moves with an induction number;

FIG. 2 illustrates an axial configuration and an apparent resistivity-depth section, where FIG. 2a is a layout plan of the configuration, and FIG. 2b is an apparent resistivity-depth section of the configuration on an xOz plane;

FIG. 3 illustrates an equatorial configuration and an apparent resistivity-depth section, where FIG. 3a is a layout plan of the configuration, FIG. 3b is an apparent resistivity-depth section of the configuration on an x′O′z plane, and FIG. 3c is an apparent resistivity-depth section of the configuration on an rOz plane;

FIG. 4 is a layout plan of an axial configuration in Example 1;

FIG. 5 illustrates an apparent resistivity-depth section of an axial configuration along a survey line in Example 1;

FIG. 6 is a layout plan of an equatorial configuration in Example 2; and

FIG. 7 illustrates an apparent resistivity-depth section of an equatorial configuration in Example 2, where FIG. 7a is an apparent resistivity-depth section along the survey line, and

FIGS. 7b, 7c, 7d, 7e and 7f are apparent resistivity-depth sections along connecting lines from observation points No. 1, No. 2, No. 3, No. 4 and No. 5 to the source, respectively.

In the figures: 1. source, 2. observation point, 3. offset, 4. detection depth

$${δ}_{i , j}^{FD} ,$$

5. recording point

$$( {P}_{i , j}^{r} , {P}_{i , j}^{z} ) , ( {P}_{i , j}^{x} , {P}_{i , j}^{z} ) or ( {P}_{i , j}^{{x}^{′}} , {P}_{i , j}^{z} ) ,$$

6. space, and 7. apparent resistivity contour curve.

### DESCRIPTION OF EMBODIMENTS

In order to make the objectives, technical solutions, and advantages of the present disclosure clearer, the present disclosure is further described in detail below with reference to the accompanying drawings and examples. It should be understood that, the specific examples described herein are merely intended to explain the present disclosure, rather than to limit the present disclosure.

The present disclosure provides a generation method of an all-zone apparent resistivity-depth section for CSAMT, specifically including:

A horizontal positon

$${P}_{i , j}^{r}$$

and a vertical position

$${P}_{i , j}^{z}$$

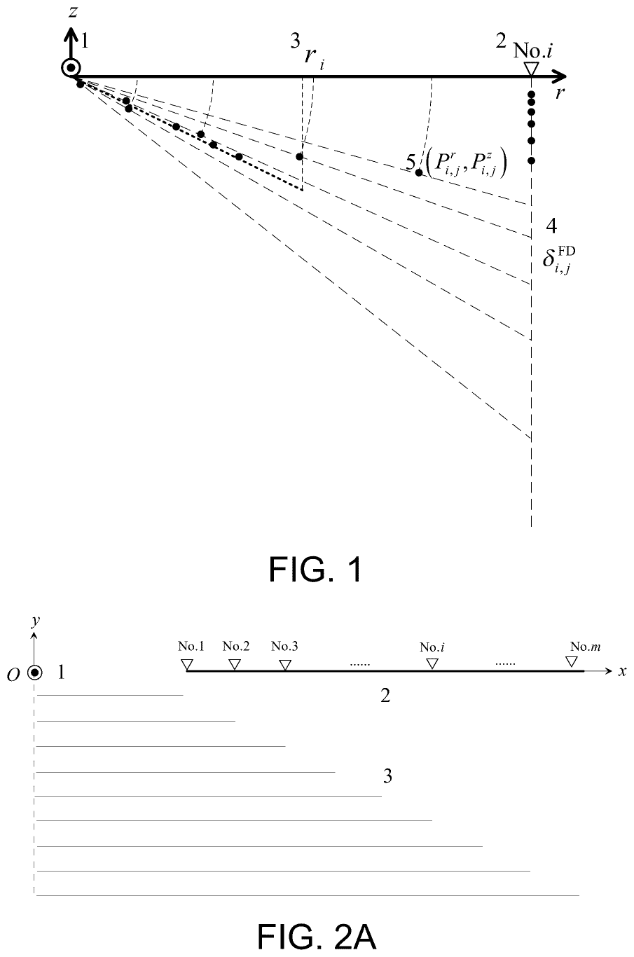

of a recording point are taken as an assignment point for an apparent resistivity (FIG. 1): in a far-field zone, the recording point is located at a detection depth under an observation point; in a transition-field zone, a radius of a wavefront decreases linearly with a decrease of an induction number, and the recording point is located at an intersection between the wavefront and a straight line from the detection depth to a source, and approaches to the source from the observation point with the decrease of the induction number; in a near-field zone, with the continuous decrease of the induction number, the horizontal position of the recording point approaches from a position adjacent to the source to a midpoint of an offset, and the vertical position of the recording point approaches from a position adjacent to the source to a fixed value proportional to the offset. In the present disclosure, the fixed value is obtained by dividing the offset rᵢ by a critical value cri^{far-tran} between the far-field zone and the transition-field zone.

More specifically, the horizontal position

$${P}_{i , j}^{r}$$

and the vertical position

$${P}_{i , j}^{z}$$

of the recording point described above in the far-field zone, the transition-field zone and the near-field zone can be expressed as:

$$\begin{matrix}{P}_{i , j}^{r} = {r}_{i} \\ {P}_{i , j}^{z} = - {δ}_{i , j}^{FD}\end{matrix} \} , {B}_{i , j} \geq {cri}^{far - tran} \qquad ( 1 a )$$

$$\begin{matrix}{P}_{i , j}^{r} = \frac{{B}_{i , j}}{\sqrt{{B}_{i , j}^{2} + 1}} \frac{{r}_{i}}{{cri}^{far - tran} - {cri}^{tran - near}} ( {B}_{i , j} - {cri}^{tran - near} ) \\ {P}_{i , j}^{z} = - \frac{1}{\sqrt{{B}_{i , j}^{2} + 1}} \frac{{r}_{i}}{{cri}^{far - tran} - {cri}^{tran - near}} ( {B}_{i , j} - {cri}^{tran - near} )\end{matrix} \} , {cri}^{tran - near} < {B}_{i , j} < {cri}^{far - tran} \qquad ( 1 b )$$

$$\begin{matrix}{P}_{i , j}^{r} = \frac{{r}_{i}}{2} ( \frac{{cri}^{tran - near} - {B}_{i , j}}{{cri}^{tran - near}} ) \\ {P}_{i , j}^{z} = - \frac{{r}_{i}}{{cri}^{far - tran}} ( \frac{{cri}^{tran - near} - {B}_{i , j}}{{cri}^{tran - near}} )\end{matrix} \} , 0 < {B}_{i , j} < {cri}^{tran - near} \qquad ( 1 c )$$

In the foregoing equations,

$${B}_{i , j} = \frac{{r}_{i}}{{δ}_{i , j}^{FD}}$$

is the induction number, rᵢ is an offset,

$${δ}_{i , j}^{FD}$$

is the detection depth, i=1, 2, . . . , m is a serial number of the observation point, j=1, 2, . . . , n is a serial number of a frequency, cri^{far-tran} is a critical value between the far-field zone and the transition-field zone, and cri^{tran-near} is a critical value between the transition-field zone and the near-field zone.

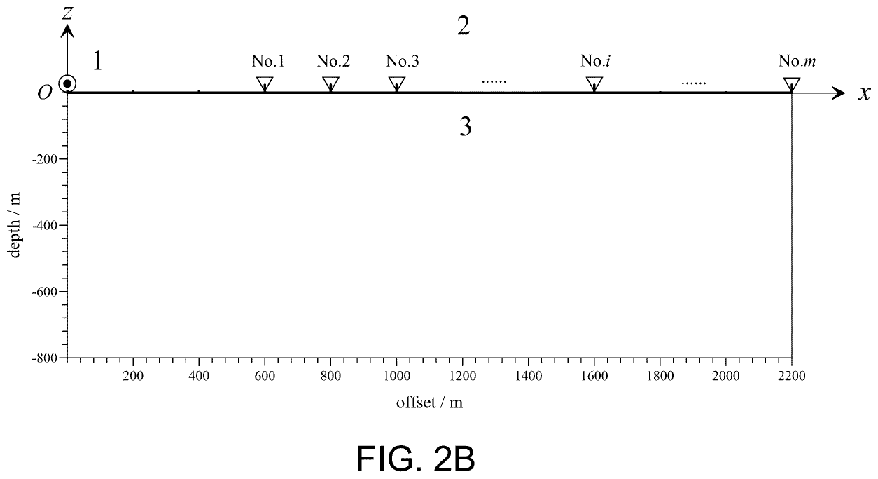

(1) For an axial configuration, assuming that the source coincides with an origin O of a rectangular coordinate system, a survey line is arranged along an x-axis (FIG. 2a), and the axial configuration has the critical value of the field zone cri^{far-tran}=5 and the critical value of the field zone cri^{tran-near}=1 in the example, if a superscript r of

$${P}_{i , j}^{r}$$

in Equation (1) is placed with x, then on an xOz plane (FIG. 2b), the horizontal position

$${P}_{i , j}^{x}$$

and the vertical position

$${P}_{i , j}^{z}$$

of the recording point for each observation point are:

$$\begin{matrix}{P}_{i , j}^{x} = {r}_{i} \\ {P}_{i , j}^{z} = - {δ}_{i , j}^{FD}\end{matrix} \} , {B}_{i , j} \geq 5 \qquad ( 2 a )$$

$$\begin{matrix}{P}_{i , j}^{x} = \frac{{B}_{i , j}}{\sqrt{{B}_{i , j}^{2} + 1}} \frac{{r}_{i}}{4} ( {B}_{i , j} - 1 ) \\ {P}_{i , j}^{z} = - \frac{1}{\sqrt{{B}_{i , j}^{2} + 1}} \frac{{r}_{i}}{4} ( {B}_{i , j} - 1 )\end{matrix} \} , 1 < {B}_{i , j} < 5 \qquad ( 2 b )$$

$$\begin{matrix}{P}_{i , j}^{x} = \frac{{r}_{i}}{2} ( 1 - {B}_{i , j} ) \\ {P}_{i , j}^{z} = - \frac{{r}_{i}}{5} ( 1 - {B}_{i , j} )\end{matrix} \} , 0 < {B}_{i , j} < 1 \qquad ( 2 c )$$

The above positions of the recording point are the assignment points for the apparent resistivity,

$${ρ}_{i , j}^{a}$$

of each observation point of the axial configuration on the xOz plane. One survey line of the axial configuration generates one apparent resistivity-depth section along the survey line.

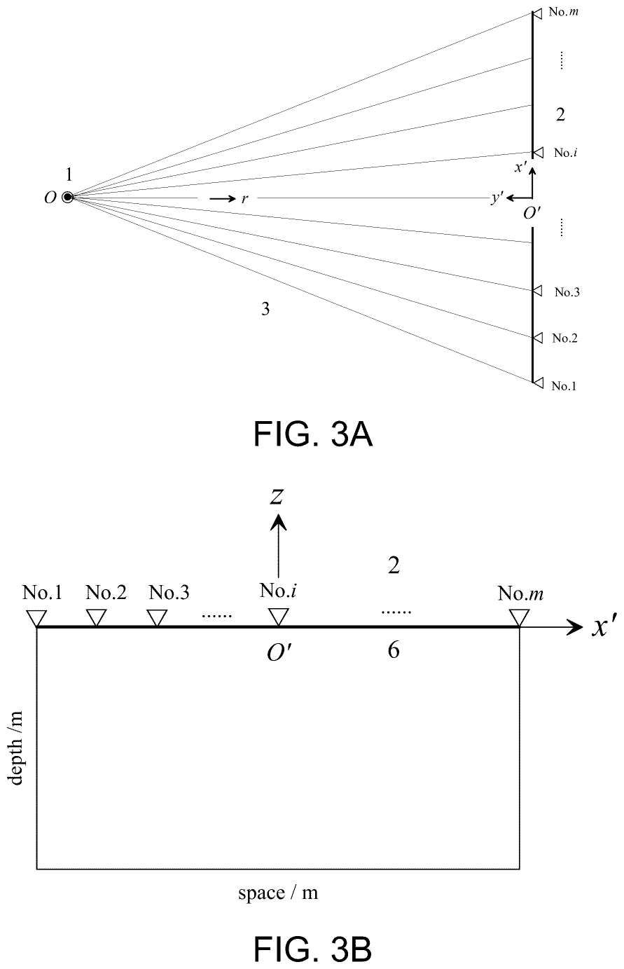

(2) For an equatorial configuration, one equatorial configuration having m observation points generates one section along a survey line, and m sections from the source to the observation points. Assuming that the survey line is arranged along an x′-axis of a rectangular coordinate system, a midpoint of the survey line serves an origin O′, the source coincides with an origin O of a cylindrical coordinate system, and a connecting line OO′ is perpendicular to the survey line (FIG. 3a), then a relationship between the offset rᵢ and the position

$${x}_{i}^{′}$$

of the observation point in the equatorial configuration is expressed as:

$${r}_{i} = \sqrt{{OO}^{′ 2} + {x}_{i}^{′2}} \qquad ( 3 )$$

If the superscript r of

$${P}_{i , j}^{r}$$

in Equation (1a) is replaced with x′ and take cri^{far-tran}=4, then the horizontal position

$${P}_{i , j}^{{x}^{′}}$$

and the vertical position

$${P}_{i , j}^{z}$$

of the recording point for each observation point on the x′O′z plane (FIG. 3b) are:

$$\begin{matrix}{P}_{i , j}^{{x}^{′}} = {x}_{i}^{′} \\ {P}_{i , j}^{z} = - {δ}_{i , j}^{FD}\end{matrix} \} , {B}_{i , j} \geq 4 \qquad ( 4 )$$

The above positions of the recording point are the assignment points for the apparent resistivity

$${ρ}_{i , j}^{a}$$

of each observation point of the equatorial configuration on the x′O′z plane.

In the example, assuming that the equatorial configuration has the critical value of the field zone cri^{far-tran}=4 and the critical value of the field zone cri^{tran-near}=1, then the horizontal position

$${P}_{i , j}^{r}$$

and the vertical position

$${P}_{i , j}^{z}$$

of the recording point for each observation point on a rOz plane (FIG. 3c) where the section from the source to the observation point is located are:

$$\begin{matrix}{P}_{i , j}^{r} = {r}_{i} \\ {P}_{i , j}^{z} = - {δ}_{i , j}^{FD}\end{matrix} \} , {B}_{i , j} \geq 4 \qquad ( 5 a )$$

$$\begin{matrix}{P}_{i , j}^{r} = \frac{{B}_{i , j}}{\sqrt{{B}_{i , j}^{2} + 1}} \frac{{r}_{i}}{3} ( {B}_{i , j} - 1 ) \\ {P}_{i , j}^{z} = - \frac{1}{\sqrt{{B}_{i , j}^{2} + 1}} \frac{{r}_{i}}{3} ( {B}_{i , j} - 1 )\end{matrix} \} , 1 < {B}_{i , j} < 4 \qquad ( 5 b )$$

$$\begin{matrix}{P}_{i , j}^{r} = \frac{{r}_{i}}{2} ( 1 - {B}_{i , j} ) \\ {P}_{i , j}^{z} = - \frac{{r}_{i}}{4} ( 1 - {B}_{i , j} )\end{matrix} \} , 0 < {B}_{i , j} < 1 \qquad ( 5 c )$$

The above positions of the recording point are the assignment points for the apparent resistivity

$${ρ}_{i , j}^{a}$$

of the observation point of the equatorial configuration on the rOz plane.

The apparent resistivity

$${ρ}_{i , j}^{a}$$

is defined and calculated from an all-zone expression of a single-component electric field or single-component magnetic field. The all-zone expression of the electric field component

$${E}_{i , j}^{x}$$

and the simple iterative expression for an all-zone apparent resistivity are:

$${E}_{i , j}^{x} = \frac{{I}_{j} l {ρ}_{i , j}^{a}}{4 π {r}_{i}^{3}} [ 2 {e}^{- {jk}_{i , j} {r}_{i}} ( 1 + {jk}_{i , j} {r}_{i} ) + 3 cos 2 {φ}_{i} - 1 ] \qquad ( 6 a )$$

$${ρ}_{i , j}^{a} = \frac{4 π {r}_{i}^{3}}{{I}_{j} l} \vert \frac{{E}_{i , j}^{x}}{2 {e}^{- {jk}_{i , j} {r}_{i}} ( 1 + {jk}_{i , j} {r}_{i} ) + 3 cos 2 {φ}_{i} - 1} \vert \qquad ( 6 b )$$

The all-zone expression of the electric field component

$${E}_{i , j}^{y}$$

and the direct calculation expression for an all-zone apparent resistivity are:

$${E}_{i , j}^{y} = \frac{3 {I}_{j} l {ρ}_{i , j}^{a}}{4 π {r}_{i}^{3}} sin 2 {φ}_{i} \qquad ( 7 a )$$

$${ρ}_{i , j}^{a} = \frac{4 π {r}_{i}^{3}}{3 {I}_{j} l} \vert \frac{{E}_{i , j}^{y}}{sin 2 {φ}_{i}} \vert \qquad ( 7 b )$$

In the foregoing equations, Iⱼ is a source current intensity of a j th frequency, l is a length of the source, J is an imaginary unit, φᵢ is an included angle between the observation point i and the source, and

$${k}_{i , j} = \frac{2 π}{{10}^{3}} \sqrt{- j \frac{{f}_{i , j}}{{ρ}_{i , j}^{a}} / 5} ,$$

f_{i,j} being the j th frequency of the observation point i, and μ₀ being a permeability of the nonmagnetic earth.

The detection depth

$${δ}_{i , j}^{FD}$$

is calculated by a skin depth equation:

$${δ}_{i , j}^{FD} \approx 503 \sqrt{\frac{{ρ}_{i , j}^{a}}{{f}_{i , j}}} \qquad ( 8 )$$

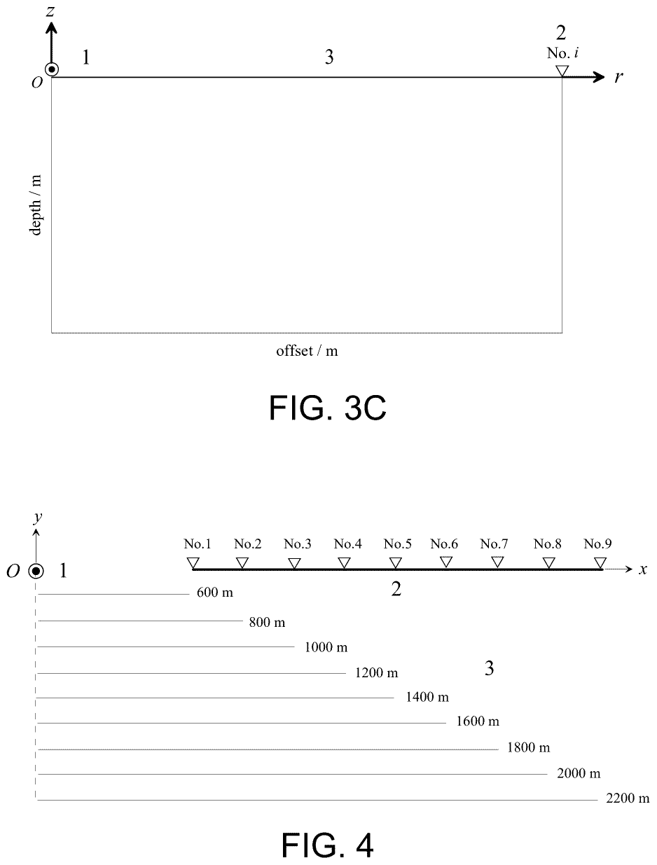

The present disclosure will be further described below in conjunction with two specific examples:
Example 1: Generation of the all-zone apparent resistivity-depth section of the axial configuration. FIG. 4 is the layout plan of the configuration, with nine observation points in total. The left part of Table 1 gives the geoelectric model, and the right part gives the offsets of the observation points.

TABLE 1
Geoelectric model and offsets for the observation points of the axial configuration

| | | Observation | | Observation | |
|---|---|---|---|---|---|
| Geoelectric model | | point | Offset rᵢ | point | Offset rᵢ |
| ρ₁ = 200 Ω · m | h₁ = 100 m | No. 1 | r₁ = 600 m | No. 6 | r₆ = 1600 m |
| ρ₂ = 100 Ω · m | h₂ = 200 m | No. 2 | r₂ = 800 m | No. 7 | r₇ = 1800 m |
| ρ₃ = 50 Ω · m | | No. 3 | r₃ = 1000 m | No. 8 | r₈ = 2000 m |
| | | No. 4 | r₄ = 1200 m | No. 9 | r₉ = 2200 m |

| Electric dipole source | No. 5 | r₅ = 1400 m | Observed Eₓ component |
|---|---|---|---|
| arranged along the | | | |
| x-axis | | | |

In Table 2, the serial numbers of frequencies are listed in the first column, the operating frequencies of each observation point are listed in the second column, the apparent resistivities

$${ρ}_{i , j}^{a}$$

calculated with Equation (6b) in the implementation method (the equations below are the equations in the implementation method) are listed in the third column, the detection depths

$${δ}_{i , j}^{FD}$$

calculated by substituting

$${ρ}_{i , j}^{a}$$

into Equation (8) are listed in the fourth column, and the induction numbers

$$\frac{{r}_{i}}{{δ}_{i , j}^{FD}}$$

are listed in the fifth column. By substituting the offsets rᵢ and the detection depths

$${δ}_{i , j}^{FD}$$

into Equation (2), horizontal pour

$${P}_{i , j}^{x}$$

and vertical positions

$${P}_{i , j}^{z}$$

of recording points for each observation point on the xOz plane are yielded, respectively listed in the sixth column and the seventh column, and taken as the assignment points for the apparent resistivities

$${ρ}_{i , j}^{a}$$

in the third column.

According to Table 2,

$${P}_{i , j}^{x}$$

### as Column A,

$${P}_{i , j}^{z}$$

### as Column B, and

$${ρ}_{i , j}^{a}$$

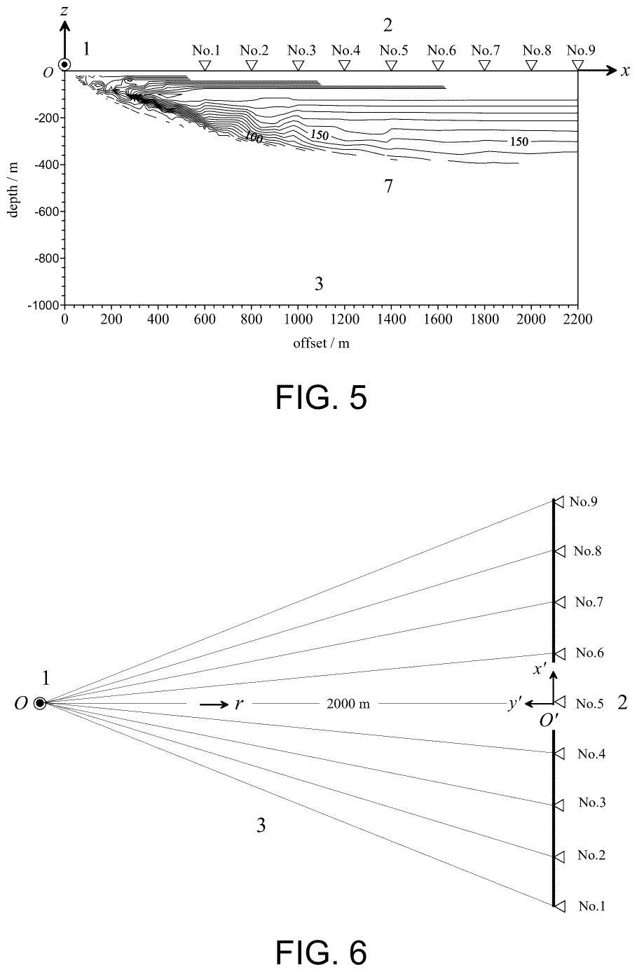

as Column C are listed in Table 3, thereby forming data of one apparent resistivity-depth section along the survey line. The all-zone apparent resistivity-depth section drawn with Surfer software is as shown in FIG. 5.

TABLE 2
Operating frequencies, apparent resistivities, detection depths, induction numbers
and recording points for each observation point of the axial configuration
Recording points of observation point No. 1 (r₁ = 600 m) at each of frequencies

| j | f_{1,j}/Hz | ${ρ}_{1 , j}^{a} / Ω \cdot m$ | ${δ}_{1 , j}^{FD} / m$ | ${B}_{1 , j} = {r}_{1} / {δ}_{1 , j}^{FD}$ | ${P}_{1 , j}^{x} / m$ | ${P}_{1 , j}^{z} / m$ |
|---|---|---|---|---|---|---|
| 1 | 8192 | 208.9 | 80.32 | 7.46 | 600.0 | −80.32 |
| 2 | 4096 | 207.3 | 113.1 | 5.30 | 600.0 | −113.1 |
| 3 | 2048 | 216.6 | 163.5 | 3.66 | 386.0 | −105.2 |
| 4 | 1024 | 175.9 | 208.4 | 2.87 | 266.0 | −92.45 |
| 5 | 512 | 134.3 | 257.6 | 2.32 | 183.1 | −78.64 |
| 6 | 256 | 116.0 | 338.7 | 1.77 | 100.7 | −56.87 |
| 7 | 128 | 109.0 | 464.3 | 1.29 | 34.65 | −26.82 |
| 8 | 64 | 106.4 | 648.7 | 0.92 | 22.53 | −9.015 |
| 9 | 32 | 105.8 | 914.7 | 0.65 | 103.2 | −41.29 |
| 10 | 16 | 105.8 | 1293. | 0.46 | 160.8 | −64.34 |
| 11 | 8 | 105.8 | 1830. | 0.32 | 201.6 | −80.65 |
| 12 | 4 | 105.9 | 2588. | 0.23 | 230.4 | −92.18 |
| 13 | 2 | 105.9 | 3660. | 0.16 | 250.8 | −100.3 |
| 14 | 1 | 106.0 | 5178. | 0.11 | 265.2 | −106.0 |
| 15 | 0.5 | 106.0 | 7325. | 0.08 | 275.4 | −110.1 |
| 16 | 0.25 | 106.0 | 10359 | 0.05 | 282.6 | −113.0 |

Recording points of observation point No. 2 (r₂ = 800 m) at each of frequencies

| j | f_{2,j}/Hz | ${ρ}_{2 , j}^{a} / Ω \cdot m$ | ${δ}_{2 , j}^{FD} / m$ | ${B}_{2 , j} = {r}_{2} / {δ}_{2 , j}^{FD}$ | ${P}_{2 , j}^{x} / m$ | ${P}_{2 , j}^{z} / m$ |
|---|---|---|---|---|---|---|
| 1 | 8192 | 209.5 | 80.44 | 9.94 | 800.0 | −80.44 |
| 2 | 4096 | 204.0 | 112.2 | 7.12 | 800.0 | −112.2 |
| 3 | 2048 | 191.8 | 153.9 | 5.19 | 800.0 | −153.9 |
| 4 | 1024 | 198.6 | 221.5 | 3.61 | 503.2 | −139.3 |
| 5 | 512 | 159.6 | 280.8 | 2.84 | 348.7 | −122.4 |
| 6 | 256 | 117.8 | 341.3 | 2.34 | 247.2 | −105.4 |
| 7 | 128 | 97.41 | 438.8 | 1.82 | 144.3 | −79.17 |
| 8 | 64 | 89.67 | 595.4 | 1.34 | 55.13 | −41.03 |
| 9 | 32 | 87.32 | 830.9 | 0.96 | 14.88 | −5.953 |
| 10 | 16 | 86.71 | 1170. | 0.68 | 126.7 | −50.68 |
| 11 | 8 | 86.71 | 1656. | 0.48 | 206.7 | −82.70 |
| 12 | 4 | 86.75 | 2342. | 0.34 | 263.3 | −105.3 |
| 13 | 2 | 86.80 | 3313. | 0.24 | 303.4 | −121.3 |
| 14 | 1 | 86.83 | 4687. | 0.17 | 331.7 | −132.6 |
| 15 | 0.5 | 86.82 | 6628. | 0.12 | 351.7 | −140.6 |
| 16 | 0.25 | 86.84 | 9375. | 0.08 | 365.8 | −146.3 |

Recording points of observation point No. 3 (r₃ = 1000 m) at each of frequencies

| j | f_{3,j}/Hz | ${ρ}_{3 , j}^{a} / Ω \cdot m$ | ${δ}_{3 , j}^{FD} / m$ | ${B}_{3 , j} = {r}_{3} / {δ}_{3 , j}^{FD}$ | ${P}_{3 , j}^{x} / m$ | ${P}_{3 , j}^{z} / m$ |
|---|---|---|---|---|---|---|
| 1 | 8192 | 209.3 | 80.40 | 12.4 | 1000. | −80.40 |
| 2 | 4096 | 205.4 | 112.6 | 8.87 | 1000. | −112.6 |
| 3 | 2048 | 186.5 | 151.8 | 6.58 | 1000. | −151.8 |
| 4 | 1024 | 179.3 | 210.5 | 4.75 | 917.4 | −193.1 |
| 5 | 512 | 181.2 | 299.2 | 3.34 | 560.8 | −167.8 |
| 6 | 256 | 136.4 | 367.1 | 2.72 | 404.4 | −148.5 |
| 7 | 128 | 98.21 | 440.5 | 2.26 | 290.4 | −127.9 |
| 8 | 64 | 81.31 | 566.9 | 1.76 | 166.1 | −94.17 |
| 9 | 32 | 75.91 | 774.7 | 1.29 | 57.45 | −44.51 |
| 10 | 16 | 74.54 | 1085. | 0.92 | 39.47 | −15.79 |
| 11 | 8 | 74.25 | 1532. | 0.65 | 173.7 | −69.48 |
| 12 | 4 | 74.29 | 2167. | 0.46 | 269.3 | −107.7 |
| 13 | 2 | 74.32 | 3066. | 0.32 | 336.9 | −134.7 |
| 14 | 1 | 74.35 | 4337. | 0.23 | 384.7 | −153.8 |
| 15 | 0.5 | 74.37 | 6134. | 0.16 | 418.4 | −167.3 |
| 16 | 0.25 | 74.35 | 8674. | 0.11 | 442.3 | −176.9 |

Recording points of observation point No. 4 (r₄ = 1200 m) at each of frequencies

| j | f_{4,j}/Hz | ${ρ}_{4 , j}^{a} / Ω \cdot m$ | ${δ}_{4 , j}^{FD} / m$ | ${B}_{4 , j} = {r}_{4} / {δ}_{4 , j}^{FD}$ | ${P}_{4 , j}^{x} / m$ | ${P}_{4 , j}^{z} / m$ |
|---|---|---|---|---|---|---|
| 1 | 8192 | 209.2 | 80.39 | 14.9 | 1200. | −80.39 |
| 2 | 4096 | 205.2 | 112.6 | 10.6 | 1200. | −112.6 |
| 3 | 2048 | 187.9 | 152.3 | 7.87 | 1200. | −152.3 |
| 4 | 1024 | 170.1 | 205.0 | 5.85 | 1200. | −205.0 |
| 5 | 512 | 174.5 | 293.6 | 4.08 | 899.3 | −220.0 |
| 6 | 256 | 155.0 | 391.4 | 3.06 | 589.0 | −192.1 |
| 7 | 128 | 108.9 | 464.0 | 2.58 | 443.6 | −171.5 |
| 8 | 64 | 79.88 | 561.9 | 2.13 | 308.4 | −144.4 |
| 9 | 32 | 69.66 | 742.1 | 1.61 | 157.3 | −97.34 |
| 10 | 16 | 67.05 | 1029. | 1.16 | 37.64 | −32.30 |
| 11 | 8 | 66.44 | 1449. | 0.82 | 103.3 | −41.33 |
| 12 | 4 | 66.41 | 2049. | 0.58 | 248.7 | −99.48 |
| 13 | 2 | 66.45 | 2899. | 0.41 | 351.6 | −140.6 |
| 14 | 1 | 66.47 | 4101. | 0.29 | 424.4 | −169.7 |
| 15 | 0.5 | 66.49 | 5800. | 0.20 | 475.8 | −190.3 |
| 16 | 0.25 | 66.50 | 8204. | 0.14 | 512.2 | −204.8 |

Recording points of observation point No. 5 (r₅ = 1400 m) at each of frequencies

| j | f_{5,j}/Hz | ${ρ}_{5 , j}^{a} / Ω \cdot m$ | ${δ}_{5 , j}^{FD} / m$ | ${B}_{5 , j} = {r}_{5} / {δ}_{5 , j}^{FD}$ | ${P}_{5 , j}^{x} / m$ | ${P}_{5 , j}^{z} / m$ |
|---|---|---|---|---|---|---|
| 1 | 8192 | 209.2 | 80.38 | 17.4 | 1400. | −80.38 |
| 2 | 4096 | 205.1 | 112.5 | 12.4 | 1400. | −112.5 |
| 3 | 2048 | 188.8 | 152.7 | 9.16 | 1400. | −152.7 |
| 4 | 1024 | 169.6 | 204.7 | 6.83 | 1400. | −204.7 |
| 5 | 512 | 160.2 | 281.3 | 4.97 | 1364. | −274.1 |
| 6 | 256 | 161.7 | 399.7 | 3.50 | 842.0 | −240.4 |
| 7 | 128 | 122.8 | 492.8 | 2.84 | 607.6 | −213.9 |
| 8 | 64 | 84.30 | 577.3 | 2.42 | 461.0 | −190.1 |
| 9 | 32 | 67.18 | 728.8 | 1.92 | 285.9 | −148.8 |
| 10 | 16 | 62.69 | 995.7 | 1.40 | 115.8 | −82.36 |
| 11 | 8 | 61.71 | 1397. | 1.00 | 0.519 | −0.517 |
| 12 | 4 | 61.51 | 1972. | 0.70 | 203.1 | −81.27 |
| 13 | 2 | 61.52 | 2789. | 0.50 | 348.7 | −139.4 |
| 14 | 1 | 61.56 | 3946. | 0.35 | 451.6 | −180.6 |
| 15 | 0.5 | 61.57 | 5582. | 0.25 | 524.4 | −209.7 |
| 16 | 0.25 | 61.58 | 7894. | 0.17 | 575.8 | −230.3 |

Recording points of observation point No. 6 (r₆ = 1600 m) at each of frequencies

| j | f_{6,j}/Hz | ${ρ}_{6 , j}^{a} / Ω \cdot m$ | ${δ}_{6 , j}^{FD} / m$ | ${B}_{6 , j} = {r}_{6} / {δ}_{6 , j}^{FD}$ | ${P}_{6 , j}^{x} / m$ | ${P}_{6 , j}^{z} / m$ |
|---|---|---|---|---|---|---|
| 1 | 8192 | 209.2 | 80.38 | 19.9 | 1600. | −80.38 |
| 2 | 4096 | 205.0 | 112.5 | 14.2 | 1600. | −112.5 |
| 3 | 2048 | 188.8 | 152.7 | 10.4 | 1600. | −152.7 |
| 4 | 1024 | 170.8 | 205.4 | 7.78 | 1600. | −205.4 |
| 5 | 512 | 154.9 | 276.7 | 5.78 | 1600. | −276.7 |
| 6 | 256 | 152.9 | 388.7 | 4.11 | 1210. | −294.2 |
| 7 | 128 | 133.6 | 513.9 | 3.11 | 804.6 | −258.4 |
| 8 | 64 | 92.43 | 604.4 | 2.64 | 616.2 | −232.8 |
| 9 | 32 | 67.54 | 730.7 | 2.18 | 432.7 | −197.6 |
| 10 | 16 | 60.27 | 976.3 | 13 | 218.1 | −133.0 |
| 11 | 8 | 58.71 | 1362. | 1.17 | 53.01 | −45.15 |
| 12 | 4 | 58.45 | 1922. | 0.83 | 134.3 | −53.73 |
| 13 | 2 | 58.42 | 2718. | 0.58 | 329.1 | −131.6 |
| 14 | 1 | 58.46 | 3845. | 0.41 | 467.1 | −186.8 |
| 15 | 0.5 | 58.46 | 5439. | 0.29 | 564.6 | −225.8 |
| 16 | 0.25 | 58.47 | 7692. | 0.20 | 633.6 | −253.4 |

Recording points of observation point No. 7 (r₇ =1800 m) at each of frequencies

| j | f_{7,j}/Hz | ${ρ}_{7 , j}^{a} / Ω \cdot m$ | ${δ}_{7 , j}^{FD} / m$ | ${B}_{7 , j} = {r}_{7} / {δ}_{7 , j}^{FD}$ | ${P}_{7 , j}^{x} / m$ | ${P}_{7 , j}^{z} / m$ |
|---|---|---|---|---|---|---|
| 1 | 8192 | 209.2 | 80.38 | 22.3 | 1800. | −80.38 |
| 2 | 4096 | 205.0 | 112.5 | 15.9 | 1800. | −112.5 |
| 3 | 2048 | 188.6 | 152.6 | 11.7 | 1800. | −152.6 |
| 4 | 1024 | 171.4 | 205.8 | 8.74 | 1800. | −205.8 |
| 5 | 512 | 154.0 | 275.9 | 6.52 | 1800. | −275.9 |
| 6 | 256 | 142.3 | 375.1 | 4.79 | 1673. | −348.7 |
| 7 | 128 | 137.3 | 520.9 | 3.45 | 1061. | −307.1 |
| 8 | 64 | 101.5 | 633.4 | 2.84 | 781.6 | −275.0 |
| 9 | 32 | 70.39 | 746.0 | 2.41 | 587.2 | −243.4 |
| 10 | 16 | 59.20 | 967.5 | 1.86 | 340.9 | −183.3 |
| 11 | 8 | 56.89 | 1341. | 1.34 | 123.3 | −91.91 |
| 12 | 4 | 56.47 | 1890. | 0.95 | 42.86 | −17.14 |
| 13 | 2 | 56.40 | 2671. | 0.67 | 293.5 | −117.4 |
| 14 | 1 | 56.44 | 3779. | 0.47 | 471.3 | −188.5 |
| 15 | 0.5 | 56.44 | 5344. | 0.33 | 596.8 | −238.7 |
| 16 | 0.25 | 56.44 | 7558. | 0.23 | 685.6 | −274.2 |

Recording points of observation point No. 8 (r₈ = 2000 m) at each of frequencies

| j | f_{8,j}/Hz | ${ρ}_{8 , j}^{a} / Ω \cdot m$ | ${δ}_{8 , j}^{FD} / m$ | ${B}_{8 , j} = {r}_{8} / {δ}_{8 , j}^{FD}$ | ${P}_{8 , j}^{x} / m$ | ${P}_{8 , j}^{z} / m$ |
|---|---|---|---|---|---|---|
| 1 | 8192 | 209.2 | 80.38 | 24.8 | 2000. | −80.38 |
| 2 | 4096 | 205.0 | 112.5 | 17.7 | 2000. | −112.5 |
| 3 | 2048 | 188.6 | 152.6 | 13.1 | 2000. | −152.6 |
| 4 | 1024 | 171.4 | 205.8 | 9.71 | 2000. | −205.8 |
| 5 | 512 | 154.8 | 276.6 | 7.23 | 2000. | −276.6 |
| 6 | 256 | 137.1 | 368.2 | 5.43 | 2000. | −368.2 |
| 7 | 128 | 132.7 | 512.3 | 3.90 | 1406. | −360.2 |
| 8 | 64 | 109.2 | 512.3 | 3.04 | 970.5 | −318.9 |
| 9 | 32 | 74.93 | 769.7 | 2.59 | 745.8 | −287.0 |
| 10 | 16 | 59.23 | 967.7 | 2.06 | 480.0 | −232.2 |
| 11 | 8 | 55.74 | 1327. | 1.50 | 210.9 | −140.0 |
| 12 | 4 | 55.13 | 1867. | 1.07 | 25.92 | −24.20 |
| 13 | 2 | 55.03 | 2638. | 0.75 | 242.0 | −96.80 |
| 14 | 1 | 55.05 | 3732. | 0.53 | 464.1 | −185.6 |
| 15 | 0.5 | 55.08 | 5279. | 0.37 | 621.1 | −248.4 |
| 16 | 0.25 | 55.08 | 7466. | 0.26 | 732.1 | −292.8 |

Recording points of observation point No. 9 (r₉ = 2200 m) at each of frequencies

| j | f_{9,j}/Hz | ${ρ}_{9 , j}^{a} / Ω \cdot m$ | ${δ}_{9 , j}^{FD} / m$ | ${B}_{9 , j} = {r}_{9} / {δ}_{9 , j}^{FD}$ | ${P}_{9 , j}^{x} / m$ | ${P}_{9 , j}^{z} / m$ |
|---|---|---|---|---|---|---|
| 1 | 8192 | 209.2 | 80.38 | 27.3 | 2200. | −80.38 |
| 2 | 4096 | 205.0 | 112.5 | 19.5 | 2200. | −112.5 |
| 3 | 2048 | 188.5 | 152.6 | 14.4 | 2200. | −152.6 |
| 4 | 1024 | 171.4 | 205.8 | 10.6 | 2200. | −205.8 |
| 5 | 512 | 155.5 | 277.2 | 7.93 | 2200. | −277.2 |
| 6 | 256 | 135.5 | 366.0 | 6.01 | 2200. | −366.0 |
| 7 | 128 | 124.7 | 496.6 | 4.42 | 1840. | −415.3 |
| 8 | 64 | 113.9 | 671.1 | 3.27 | 1198. | −365.5 |
| 9 | 32 | 80.48 | 797.7 | 2.75 | 908.9 | −329.5 |
| 10 | 16 | 60.16 | 975.3 | 2.25 | 631.2 | −279.8 |
| 11 | 8 | 55.12 | 1320. | 1.66 | 314.1 | −188.5 |
| 12 | 4 | 54.22 | 1852. | 1.18 | 79.05 | −66.54 |
| 13 | 2 | 54.11 | 2616. | 0.84 | 175.1 | −70.04 |
| 14 | 1 | 54.10 | 3699. | 0.59 | 445.9 | −178.3 |
| 15 | 0.5 | 54.13 | 5234. | 0.42 | 637.6 | −255.0 |
| 16 | 0.25 | 54.13 | 7401. | 0.29 | 773.0 | −309.2 |

TABLE 3
Data for plotting the all-zone apparent resistivity-depth section of the axial
configuration
Column A corresponds to ${P}_{i , j}^{x} ,$
Column B corresponds to ${P}_{i , j}^{z} ,$
and Column C corresponds to ${ρ}_{i , j}^{a} .$

| A | B | C |
|---|---|---|
| 600.0 | −80.32 | 208.9 |
| 600.0 | −113.1 | 207.3 |
| 386.0 | −105.2 | 216.6 |
| 266.0 | −92.45 | 175.9 |
| 183.1 | −78.64 | 134.3 |
| 100.7 | −56.87 | 116.0 |
| 34.65 | −26.82 | 109.0 |
| 22.53 | −9.015 | 106.4 |
| 103.2 | −41.29 | 105.8 |
| 160.8 | −64.34 | 105.8 |
| 201.6 | −80.65 | 105.8 |
| 230.4 | −92.18 | 105.9 |
| 250.8 | −100.3 | 105.9 |
| 265.2 | −106.0 | 106.0 |
| 275.4 | −110.1 | 106.0 |
| 282.6 | −113.0 | 106.0 |
| 800.0 | −80.44 | 209.5 |
| 800.0 | −112.2 | 204.0 |
| 800.0 | −153.9 | 191.8 |
| 503.2 | −139.3 | 198.6 |
| 348.7 | −122.4 | 159.6 |
| 247.2 | −105.4 | 117.8 |
| 144.3 | −79.17 | 97.41 |
| 55.13 | −41.03 | 89.67 |
| 14.88 | −5.953 | 87.32 |
| 126.7 | −50.68 | 86.71 |
| 206.7 | −82.70 | 86.71 |
| 263.3 | −105.3 | 86.75 |
| 303.4 | −121.3 | 86.80 |
| 331.7 | −132.6 | 86.83 |
| 351.7 | −140.6 | 86.82 |
| 365.8 | −146.3 | 86.84 |
| 1000. | −80.40 | 209.3 |
| 1000. | −112.6 | 205.4 |
| 1000. | −151.8 | 186.5 |
| 917.4 | −193.1 | 179.3 |
| 560.8 | −167.8 | 181.2 |
| 404.4 | −148.5 | 136.4 |
| 290.4 | −127.9 | 98.21 |
| 166.1 | −94.17 | 81.31 |
| 57.45 | −44.51 | 75.91 |
| 39.47 | −15.79 | 74.54 |
| 173.7 | −69.48 | 74.25 |
| 269.3 | −107.7 | 74.29 |
| 336.9 | −134.7 | 74.32 |
| 384.7 | −153.8 | 74.35 |
| 418.4 | −167.3 | 74.37 |
| 442.3 | −176.9 | 74.35 |
| 1200. | −80.39 | 209.2 |
| 1200. | −112.6 | 205.2 |
| 1200. | −152.3 | 187.9 |
| 1200. | −205.0 | 170.1 |
| 899.3 | −220.0 | 174.5 |
| 589.0 | −192.1 | 155.0 |
| 443.6 | −171.5 | 108.9 |
| 308.4 | −144.4 | 79.88 |
| 157.3 | −97.34 | 69.66 |
| 37.64 | −32.30 | 67.05 |
| 103.3 | −41.33 | 66.44 |
| 248.7 | −99.48 | 66.41 |
| 351.6 | −140.6 | 66.45 |
| 424.4 | −169.7 | 66.47 |
| 475.8 | −190.3 | 66.49 |
| 512.2 | −204.8 | 66.50 |
| 1400. | −80.38 | 209.2 |
| 1400. | −112.5 | 205.1 |
| 1400. | −152.7 | 188.8 |
| 1400. | −204.7 | 169.6 |
| 1364. | −274.1 | 160.2 |
| 842.0 | −240.4 | 161.7 |
| 607.6 | −213.9 | 122.8 |
| 461.0 | −190.1 | 84.30 |
| 285.9 | −148.8 | 67.18 |
| 115.8 | −82.36 | 62.69 |
| 0.519 | −0.517 | 61.71 |
| 203.1 | −81.27 | 61.51 |
| 348.7 | −139.4 | 61.52 |
| 451.6 | −180.6 | 61.56 |
| 524.4 | −209.7 | 61.57 |
| 575.8 | −230.3 | 61.58 |
| 1600. | −80.38 | 209.2 |
| 1600. | −112.5 | 205.0 |
| 1600. | −152.7 | 188.8 |
| 1600. | −205.4 | 170.8 |
| 1600. | −276.7 | 154.9 |
| 1210. | −294.2 | 152.9 |
| 804.6 | −258.4 | 133.6 |
| 616.2 | −232.8 | 92.43 |
| 432.7 | −197.6 | 67.54 |
| 218.1 | −133.0 | 60.27 |
| 53.01 | −45.15 | 58.71 |
| 134.3 | −53.73 | 58.45 |
| 329.1 | −131.6 | 58.42 |
| 467.1 | −186.8 | 58.46 |
| 564.6 | −225.8 | 58.46 |
| 633.6 | −253.4 | 58.47 |
| 1800. | −80.38 | 209.2 |
| 1800. | −112.5 | 205.0 |
| 1800. | −152.6 | 188.6 |
| 1800. | −205.8 | 171.4 |
| 1800. | −275.9 | 154.0 |
| 1673. | −348.7 | 142.3 |
| 1061. | −307.1 | 137.3 |
| 781.6 | −275.0 | 101.5 |
| 587.2 | −243.4 | 70.39 |
| 340.9 | −183.3 | 59.20 |
| 123.3 | −91.91 | 56.89 |
| 42.86 | −17.14 | 56.47 |
| 293.5 | −117.4 | 56.40 |
| 471.3 | −188.5 | 56.44 |
| 596.8 | −238.7 | 56.44 |
| 685.6 | −274.2 | 56.44 |
| 2000. | −80.38 | 209.2 |
| 2000. | −112.5 | 205.0 |
| 2000. | −152.6 | 188.6 |
| 2000. | −205.8 | 171.4 |
| 2000. | −276.6 | 154.8 |
| 2000. | −368.2 | 137.1 |
| 1406. | −360.2 | 132.7 |
| 970.5 | −318.9 | 109.2 |
| 745.8 | −287.0 | 74.93 |
| 480.0 | −232.2 | 59.23 |
| 210.9 | −140.0 | 55.74 |
| 25.92 | −24.20 | 55.13 |
| 242.0 | −96.80 | 55.03 |
| 464.1 | −185.6 | 55.05 |
| 621.1 | −248.4 | 55.08 |
| 732.1 | −292.8 | 55.08 |
| 2200. | −80.38 | 209.2 |
| 2200. | −112.5 | 205.0 |
| 2200. | −152.6 | 188.5 |
| 2200. | −205.8 | 171.4 |
| 2200. | −277.2 | 155.5 |
| 2200. | −366.0 | 135.5 |
| 1840. | −415.3 | 124.7 |
| 1198. | −365.5 | 113.9 |
| 908.9 | −329.5 | 80.48 |
| 631.2 | −279.8 | 60.16 |
| 314.1 | −188.5 | 55.12 |
| 79.05 | −66.54 | 54.22 |
| 175.1 | −70.04 | 54.11 |
| 445.9 | −178.3 | 54.10 |
| 637.6 | −255.0 | 54.13 |
| 773.0 | −309.2 | 54.13 |

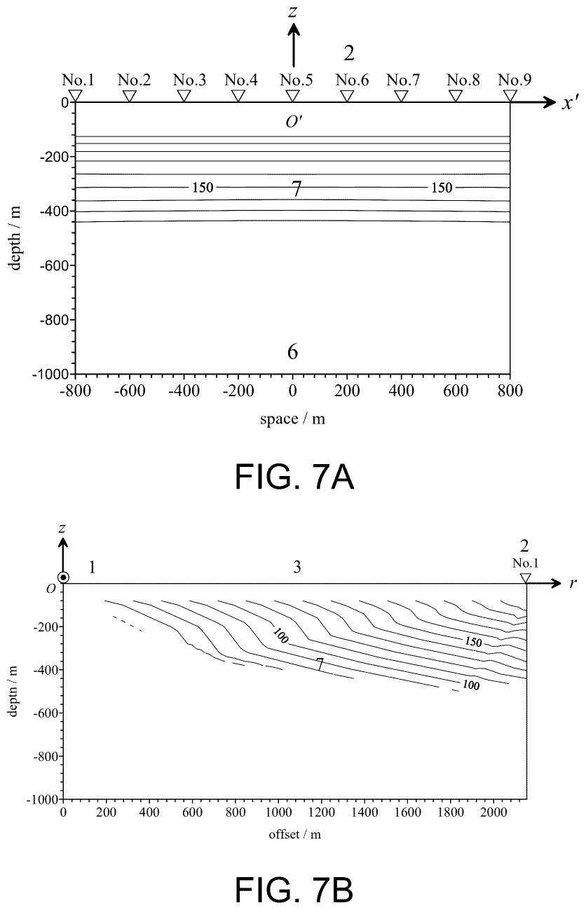

Example 2: Generation of the all-zone apparent resistivity-depth section of the equatorial configuration. FIG. 6 is the layout plan of the configuration, with nine observation points in total. The distance between the survey line and the source is 2,000 m, and the space between the observation points is 200 m. The left part of Table 4 gives the geoelectric model, and the right part gives the offsets of the observation points calculated from Equation (3).

TABLE 4
Geoelectric model and offsets for the observation
points of the equatorial configuration

| | | Observation | | Observation | |
|---|---|---|---|---|---|
| Geoelectric model | | point | Offset rᵢ | point | Offset rᵢ |
| ρ₁ = 200 Ω · m | h₁ = 100 m | No. 1 | r₁ = 2154 m | No. 6 | r₆ = 2010 m |
| ρ₂ = 100 Ω · m | h₂ = 200 m | No. 2 | r₂ = 2088 m | No. 7 | r₇ = 2040 m |
| ρ₃ = 50 Ω · m | | No. 3 | r₃ = 2040 m | No. 8 | r₈ = 2088 m |
| | | No. 4 | r₄ = 2010 m | No. 9 | r₉ = 2154 m |

| Electric dipole source | No. 5 | r₅ = 2000 m | Observed Eₓ component |
|---|---|---|---|
| arranged along the | | | |
| x-axis | | | |

In Table 5, the serial numbers of frequencies are listed in the first column, the operating frequencies of each observation point are listed in the second column, the apparent resistivities

$${ρ}_{i , j}^{a}$$

calculated from Equation (6b) are listed in the third column, the detection depths

$${δ}_{i , j}^{FD}$$

calculated by substituting

$${ρ}_{i , j}^{a}$$

into Equation (8) are listed in the fourth column, and the induction numbers

$$\frac{{r}_{i}}{{δ}_{i , j}^{FD}}$$

are listed in the fifth column. By substituting the offsets rᵢ and the detection depths

$${δ}_{i , j}^{FD}$$

into Equation (5), horizontal positions

$${P}_{i , j}^{r}$$

and vertical positions

$${P}_{i , j}^{z}$$

of recording points for each observation point on the rOz plane are yielded, respectively listed in the sixth column and the seventh column, and taken as the assignment points for the apparent resistivities

$${ρ}_{i , j}^{a}$$

in the third column. The horizontal positions

$${P}_{i , j}^{{x}^{′}}$$

and the vertical positions

$${P}_{i , j}^{z}$$

of the recording points for each observation point on the x′O′z can be obtained directly from the table according to Equation (4), and taken as the corresponding assignment point for the apparent resistivities

$${ρ}_{i , j}^{a}$$

in the third column on the plane.

According to Table 5,

$${P}_{i , j}^{r}$$

(including

$${P}_{i , j}^{{x}^{′}} )$$

### as Column A,

$${P}_{i , j}^{z}$$

### as Column B, and

$${ρ}_{i , j}^{a}$$

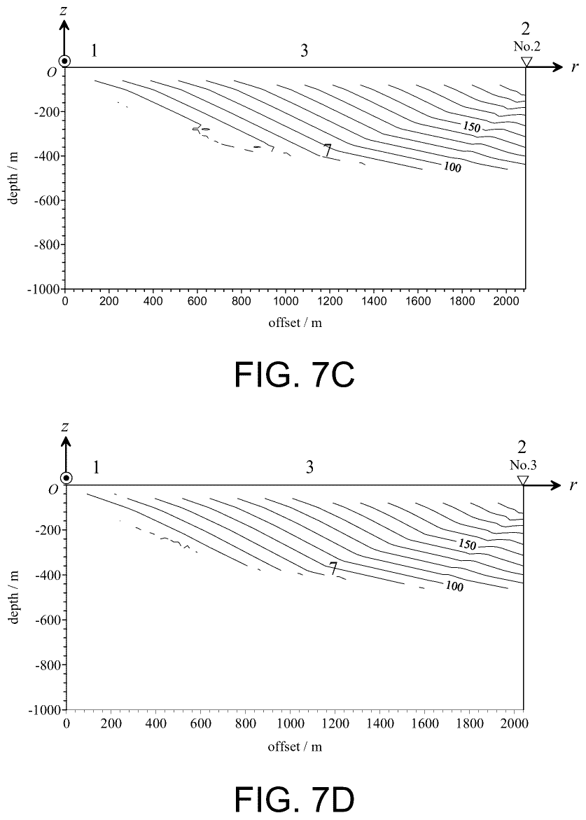

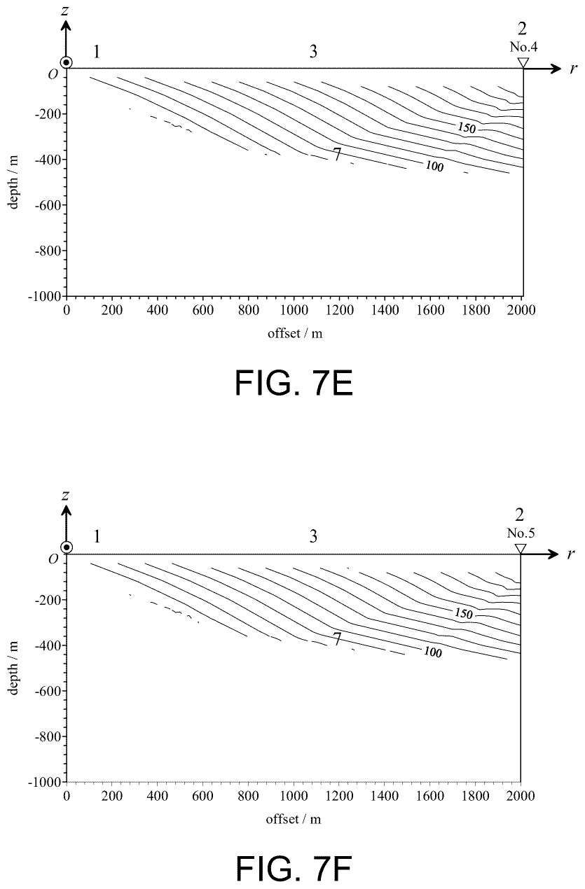

as Column C are listed in Table 6, thereby forming data of one apparent resistivity-depth section along the survey line and nine apparent resistivity-depth sections from the observation points to the source. The all-zone apparent resistivity-depth sections drawn with Surfer software are as shown in FIG. 7. FIG. 7a is the section along the survey line. FIGS. 7b-7f are the sections from the observation points to the source (only five sections are drawn due to the symmetry).

TABLE 5
Operating frequencies, apparent resistivities, detection depths, induction numbers
and recording points for each observation point of the equatorial configuration
Recording points of observation point No. 1 (r₁ = 2154 m, ${x}_{1}^{′} = - 800 m )$
at each of frequencies

| j | f_{1,j/Hz} | ${ρ}_{1 , j}^{a} / Ω \cdot m$ | ${δ}_{1 , j}^{FD} / m$ | ${B}_{1 , j} = {r}_{1} / {δ}_{1 , j}^{FD}$ | ${P}_{1 , j}^{r} / m$ | ${P}_{1 , j}^{z} / m$ |
|---|---|---|---|---|---|---|
| 1 | 8192 | 209.1 | 80.36 | 26.8 | 2154. | −80.36 |
| 2 | 4096 | 205.3 | 112.6 | 19.1 | 2154. | −112.6 |
| 3 | 2048 | 189.2 | 152.8 | 14.0 | 2154. | −152.8 |
| 4 | 1024 | 171.9 | 206.0 | 10.4 | 2154. | −206.0 |
| 5 | 512 | 157.0 | 278.5 | 7.73 | 2154. | −278.5 |
| 6 | 256 | 138.6 | 370.1 | 5.81 | 2154. | −370.1 |
| 7 | 128 | 112.0 | 470.5 | 4.57 | 2154. | −470.5 |
| 8 | 64 | 88.66 | 592.0 | 3.63 | 1826. | −502.0 |
| 9 | 32 | 74.70 | 768.5 | 2.80 | 1219. | −434.9 |
| 0 | 16 | 67.22 | 1031. | 2.08 | 705.3 | −337.6 |
| 11 | 8 | 62.22 | 1403. | 1.53 | 322.0 | −209.7 |
| 12 | 4 | 57.77 | 1911. | 1.12 | 68.07 | −60.41 |
| 13 | 2 | 54.12 | 2616. | 0.82 | 190.4 | −95.23 |
| 14 | 1 | 52.05 | 3629. | 0.59 | 437.7 | −218.8 |
| 15 | 0.5 | 51.22 | 5091. | 0.42 | 621.3 | −310.6 |
| 16 | 0.25 | 50.96 | 7181. | 0.29 | 753.9 | −376.9 |

Recording points of observation point No. 2 (r₂ = 2088 m, ${x}_{2}^{′} = - 600 m )$
at each of frequencies

| j | f_{2,j/Hz} | ${ρ}_{2 , j}^{a} / Ω \cdot m$ | ${δ}_{2 , j}^{FD} / m$ | ${B}_{2 , j} = {r}_{2} / {δ}_{2 , j}^{F D}$ | ${P}_{2 , j}^{r} / m$ | ${P}_{2 , j}^{z} / m$ |
|---|---|---|---|---|---|---|
| 1 | 8192 | 209.1 | 80.37 | 25.9 | 2088 | −80.37 |
| 2 | 4096 | 205.3 | 112.6 | 18.5 | 2088 | −112.6 |
| 3 | 2048 | 189.1 | 152.8 | 13.6 | 2088 | −152.8 |
| 4 | 1024 | 171.8 | 206.0 | 10.1 | 2088 | −206.0 |
| 5 | 512 | 157.1 | 278.6 | 7.49 | 2088 | −278.6 |
| 6 | 256 | 138.3 | 369.7 | 5.64 | 2088 | −369.7 |
| 7 | 128 | 111.5 | 469.4 | 4.44 | 2088 | −469.4 |
| 8 | 64 | 88.85 | 592.6 | 3.52 | 1689. | −479.4 |
| 9 | 32 | 75.03 | 770.2 | 2.71 | 1117. | −412.1 |
| 10 | 16 | 67.15 | 1030. | 2.02 | 640.5 | −316.1 |
| 11 | 8 | 61.61 | 1395. | 1.49 | 286.8 | −191.7 |
| 12 | 4 | 57.04 | 1899. | 1.09 | 51.05 | −46.44 |
| 13 | 2 | 53.88 | 2610. | 0.79 | 209.0 | −104.5 |
| 14 | 1 | 52.36 | 3639. | 0.57 | 445.1 | −222.5 |
| 15 | 0.5 | 51.80 | 5120. | 0.40 | 618.2 | −309.1 |
| 16 | 0.25 | 51.64 | 7229. | 0.28 | 742.4 | −371.2 |

Recording points of observation point No. 3 (r₃ = 2040 m, ${x}_{3}^{′} = - 400 m )$
at each of frequencies

| j | f_{3,j/Hz} | ${ρ}_{3 , j}^{a} / Ω \cdot m$ | ${δ}_{3 , j}^{FD} / m$ | ${B}_{3 , j} = {r}_{3} / {δ}_{3 , j}^{F D}$ | ${P}_{3 , j}^{r} / m$ | ${P}_{3 , j}^{z} / m$ |
|---|---|---|---|---|---|---|
| 1 | 8192 | 209.1 | 80.37 | 25.3 | 2040. | −80.37 |
| 2 | 4096 | 205.3 | 112.6 | 18.1 | 2040. | −112.6 |
| 3 | 2048 | 189.1 | 152.8 | 13.3 | 2040. | −152.8 |
| 4 | 1024 | 171.8 | 206.0 | 9.89 | 2040. | −206.0 |
| 5 | 512 | 157.2 | 278.7 | 7.31 | 2040. | −278.7 |
| 6 | 256 | 138.0 | 369.4 | 5.52 | 2040. | −369.4 |
| 7 | 128 | 111.2 | 468.9 | 4.34 | 2040. | −468.9 |
| 8 | 64 | 88.99 | 593.1 | 3.43 | 1592. | −463.1 |
| 9 | 32 | 75.23 | 771.2 | 2.64 | 1046. | −395.5 |
| 0 | 16 | 67.02 | 1029. | 1.98 | 595.8 | −300.6 |
| 11 | 8 | 61.16 | 1390. | 1.46 | 262.2 | −178.7 |
| 12 | 4 | 56.67 | 1893. | 1.07 | 38.61 | −35.84 |
| 13 | 2 | 53.85 | −2610. | 0.78 | 222.8 | −111.4 |
| 14 | 1 | 52.60 | −3648. | 0.55 | 449.6 | −224.8 |
| 15 | 0.5 | 52.17 | −5138. | 0.39 | 615.0 | −307.5 |
| 16 | 0.25 | 52.05 | −7258. | 0.28 | 733.3 | −366.6 |

Recording points of observation point No. 4 (r₄ = 2010 m, ${x}_{4}^{′} = - 200 m )$
at each of frequencies

| j | f_{4,j/Hz} | ${ρ}_{4 , j}^{a} / Ω \cdot m$ | ${δ}_{4 , j}^{FD} / m$ | ${B}_{4 , j} = {r}_{4} / {δ}_{4 , j}^{F D}$ | ${P}_{4 , j}^{r} / m$ | ${P}_{4 , j}^{z} / m$ |
|---|---|---|---|---|---|---|
| 1 | 8192 | 209.1 | 80.37 | 25.0 | 2010. | −80.37 |
| 2 | 4096 | 205.3 | 112.6 | 17.8 | 2010. | −112.6 |
| 3 | 2048 | 189.1 | 152.8 | 13.1 | 2010. | −152.8 |
| 4 | 1024 | 171.8 | 206.0 | 9.75 | 2010. | −206.0 |
| 5 | 512 | 157.2 | 278.7 | 7.21 | 2010. | −278.7 |
| 6 | 256 | 137.7 | 368.9 | 5.44 | 2010. | −368.9 |
| 7 | 128 | 111.1 | 468.7 | 4.28 | 2010. | −468.7 |
| 8 | 64 | 89.08 | 593.4 | 3.38 | 1533. | −452.8 |
| 9 | 32 | 75.32 | 771.7 | 2.60 | 1003. | −385.3 |
| 0 | 16 | 66.92 | 1028. | 1.95 | 568.8 | −291.1 |
| 11 | 8 | 60.93 | 1388. | 1.44 | 246.9 | −170.5 |
| 12 | 4 | 56.47 | 1890. | 1.06 | 30.99 | −29.14 |
| 13 | 2 | 53.87 | 2610. | 0.76 | 231.1 | −115.5 |
| 14 | 1 | 52.76 | 3653. | 0.55 | 452.1 | −226.0 |
| 15 | 0.5 | 52.40 | 5149. | 0.39 | 612.7 | −306.3 |
| 16 | 0.25 | 52.29 | 7274. | 0.27 | 727.3 | −363.6 |

Recording points of observation point No. 5 (r₅ = 2000 m, ${x}_{5}^{′} = 0 m )$
at each of frequencies

| j | f_{5,j/Hz} | ${ρ}_{5 , j}^{a} / Ω \cdot m$ | ${δ}_{5 , j}^{FD} / m$ | ${B}_{5 , j} = {r}_{5} / {δ}_{5 , j}^{FD}$ | ${P}_{5 , j}^{r} / m$ | ${P}_{5 , j}^{z} / m$ |
|---|---|---|---|---|---|---|
| 1 | 8192 | 209.1 | 80.37 | 24.8 | 2000. | −80.37 |
| 2 | 4096 | 205.3 | 112.6 | 17.7 | 2000. | −112.6 |
| 3 | 2048 | 189.1 | 152.8 | 13.0 | 2000. | −152.8 |
| 4 | 1024 | 171.8 | 206.0 | 9.70 | 2000. | −206.0 |
| 5 | 512 | 157.2 | 278.7 | 7.17 | 2000. | −278.7 |
| 6 | 256 | 137.6 | 368.8 | 5.42 | 2000. | −368.8 |
| 7 | 128 | 111.1 | 468.6 | 4.26 | 2000. | −468.6 |
| 8 | 64 | 89.11 | 593.5 | 3.36 | 1514. | −449.4 |
| 9 | 32 | 75.35 | 771.8 | 2.59 | 989.5 | −381.9 |
| 10 | 16 | 66.93 | 1028. | 1.94 | 559.6 | −287.8 |
| 11 | 8 | 60.85 | 1387. | 1.44 | 241.9 | −167.8 |
| 12 | 4 | 56.41 | 1889. | 1.05 | 28.46 | −26.88 |
| 13 | 2 | 53.88 | 2610. | 0.76 | 233.9 | −116.9 |
| 14 | 1 | 52.82 | 3655. | 0.54 | 452.9 | −226.4 |
| 15 | 0.5 | 52.47 | 5152. | 0.38 | 611.8 | −305.9 |
| 16 | 0.25 | 52.37 | 7280. | 0.27 | 725.2 | −362.6 |

Recording points of observation point No. 6 (r₆ = 2010 m, ${x}_{6}^{′} = 200 m )$
at each of frequencies

| j | f_{6,j/Hz} | ${ρ}_{6 , j}^{a} / Ω \cdot m$ | ${δ}_{6 , j}^{FD} / m$ | ${B}_{6 , j} = {r}_{6} / {δ}_{6 , j}^{FD}$ | ${P}_{6 , j}^{r} / m$ | ${P}_{6 , j}^{z} / m$ |
|---|---|---|---|---|---|---|
| 1 | 8192 | 209.1 | 80.37 | 25.0 | 2010. | −80.37 |
| 2 | 4096 | 205.3 | 112.6 | 17.8 | 2010. | −112.6 |
| 3 | 2048 | 189.1 | 152.8 | 13.1 | 2010. | −152.8 |
| 4 | 1024 | 171.8 | 206.0 | 9.75 | 2010. | −206.0 |
| 5 | 512 | 157.2 | 278.7 | 7.21 | 2010. | −278.7 |
| 6 | 256 | 137.7 | 368.9 | 5.44 | 2010. | −368.9 |
| 7 | 128 | 111.1 | 468.7 | 4.28 | 2010. | −468.7 |
| 8 | 64 | 89.08 | 593.4 | 3.38 | 1533. | −452.8 |
| 9 | 32 | 75.32 | 771.7 | 2.60 | 1003. | −385.3 |
| 0 | 16 | 66.92 | 1028. | 1.95 | 568.8 | −291.1 |
| 11 | 8 | 60.93 | 1388. | 1.44 | 246.9 | −170.5 |
| 12 | 4 | 56.47 | 1890. | 1.06 | 30.99 | −29.14 |
| 13 | 2 | 53.87 | 2610. | 0.76 | 231.1 | −115.5 |
| 14 | 1 | 52.76 | 3653. | 0.55 | 452.1 | −226.0 |
| 15 | 0.5 | 52.40 | 5149. | 0.39 | 612.7 | −306.3 |
| 16 | 0.25 | 52.29 | 7274. | 0.27 | 727.3 | −363.6 |

Recording points of observation point No. 7 (r₇ = 2040 m, ${x}_{7}^{′} = 400 m )$
at each of frequencies

| j | f_{7,j/Hz} | ${ρ}_{7 , j}^{a} / Ω \cdot m$ | ${δ}_{7 , j}^{FD} / m$ | ${B}_{7 , j} = {r}_{7} / {δ}_{7 , j}^{FD}$ | ${P}_{7 , j}^{r} / m$ | ${P}_{7 , j}^{z} / m$ |
|---|---|---|---|---|---|---|
| 1 | 8192 | 209.1 | 80.37 | 25.3 | 2040. | −80.37 |
| 2 | 4096 | 205.3 | 112.6 | 18.1 | 2040. | −112.6 |
| 3 | 2048 | 189.1 | 152.8 | 13.3 | 2040. | −152.8 |
| 4 | 1024 | 171.8 | 206.0 | 9.89 | 2040. | −206.0 |
| 5 | 512 | 157.2 | 278.7 | 7.31 | 2040. | −278.7 |
| 6 | 256 | 138.0 | 369.4 | 5.52 | 2040. | −369.4 |
| 7 | 128 | 111.2 | 468.9 | 4.34 | 2040. | −468.9 |
| 8 | 64 | 88.99 | 593.1 | 3.43 | 1592. | −463.1 |
| 9 | 32 | 75.23 | 771.2 | 2.64 | 1046. | −395.5 |
| 0 | 16 | 67.02 | 1029. | 1.98 | 595.8 | −300.6 |
| 11 | 8 | 61.16 | 1390. | 1.46 | 262.2 | −178.7 |
| 12 | 4 | 56.67 | 1893. | 1.07 | 38.61 | −35.84 |
| 13 | 2 | 53.85 | −2610. | 0.78 | 222.8 | −111.4 |
| 14 | 1 | 52.60 | −3648. | 0.55 | 449.6 | −224.8 |
| 15 | 0.5 | 52.17 | −5138. | 0.39 | 615.0 | −307.5 |
| 16 | 0.25 | 52.05 | −7258. | 0.28 | 733.3 | −366.6 |

Recording points of observation point No. 8 (r₈ = 2088 m, ${x}_{8}^{′} = 600 m )$
at each of frequencies

| j | f_{8,j/Hz} | ${ρ}_{8 , j}^{a} / Ω \cdot m$ | ${δ}_{8 , j}^{FD} / m$ | ${B}_{8 , j} / {r}_{8} / {δ}_{8 , j}^{FD}$ | ${P}_{8 , j}^{r} / m$ | ${P}_{8 , j}^{z} / m$ |
|---|---|---|---|---|---|---|
| 1 | 8192 | 209.1 | 80.37 | 25.9 | 2088 | −80.37 |
| 2 | 4096 | 205.3 | 112.6 | 18.5 | 2088 | −112.6 |
| 3 | 2048 | 189.1 | 152.8 | 13.6 | 2088 | −152.8 |
| 4 | 1024 | 171.8 | 206.0 | 10.1 | 2088 | −206.0 |
| 5 | 512 | 157.1 | 278.6 | 7.49 | 2088 | −278.6 |
| 6 | 256 | 138.3 | 369.7 | 5.64 | 2088 | −369.7 |
| 7 | 128 | 111.5 | 469.4 | 4.44 | 2088 | −469.4 |
| 8 | 64 | 88.85 | 592.6 | 3.52 | 1689. | −479.4 |
| 9 | 32 | 75.03 | 770.2 | 2.71 | 1117. | −412.1 |
| 10 | 16 | 67.15 | 1030. | 2.02 | 640.5 | −316.1 |
| 11 | 8 | 61.61 | 1395. | 1.49 | 286.8 | −191.7 |
| 12 | 4 | 57.04 | 1899. | 1.09 | 51.05 | −46.44 |
| 13 | 2 | 53.88 | 2610. | 0.79 | 209.0 | −104.5 |
| 14 | 1 | 52.36 | 3639. | 0.57 | 445.1 | −222.5 |
| 15 | 0.5 | 51.80 | 5120. | 0.40 | 618.2 | −309.1 |
| 16 | 0.25 | 51.64 | 7229. | 0.28 | 742.4 | −371.2 |

Recording points of observation point No. 9 (r₉ = 2154 m, ${x}_{9}^{′} = 800 m )$
at each of frequencies

| j | f_{9,j/Hz} | ${ρ}_{8 , j}^{a} / Ω \cdot m$ | ${δ}_{8 , j}^{FD} / m$ | ${B}_{8 , j} / {r}_{8} / {δ}_{8 , j}^{FD}$ | ${P}_{8 , j}^{r} / m$ | ${P}_{8 , j}^{z} / m$ |
|---|---|---|---|---|---|---|
| 1 | 8192 | 209.1 | 80.36 | 26.8 | 2154. | −80.36 |
| 2 | 4096 | 205.3 | 112.6 | 19.1 | 2154. | −112.6 |
| 3 | 2048 | 189.2 | 152.8 | 14.0 | 2154. | −152.8 |
| 4 | 1024 | 171.9 | 206.0 | 10.4 | 2154. | −206.0 |
| 5 | 512 | 157.0 | 278.5 | 7.73 | 2154. | −278.5 |
| 6 | 256 | 138.6 | 370.1 | 5.81 | 2154. | −370.1 |
| 7 | 128 | 112.0 | 470.5 | 4.57 | 2154. | −470.5 |
| 8 | 64 | 88.66 | 592.0 | 3.63 | 1826. | −502.0 |
| 9 | 32 | 74.70 | 768.5 | 2.80 | 1219. | −434.9 |
| 0 | 16 | 67.22 | 1031. | 2.08 | 705.3 | −337.6 |
| 11 | 8 | 62.22 | 1403. | 1.53 | 322.0 | −209.7 |
| 12 | 4 | 57.77 | 1911. | 1.12 | 68.07 | −60.41 |
| 13 | 2 | 54.12 | 2616. | 0.82 | 190.4 | −95.23 |
| 14 | 1 | 52.05 | 3629. | 0.59 | 437.7 | −218.8 |
| 15 | 0.5 | 51.22 | 5091. | 0.42 | 621.3 | −310.6 |
| 16 | 0.25 | 50.96 | 7181. | 0.29 | 753.9 | −376.9 |

TABLE 6
Data for plotting the all-zone apparent resistivity-depth sections of the
equatorial configuration
Column A corresponds to ${P}_{i , j}^{{x}^{′}} or {P}_{i , j}^{r} ,$
Column B corresponds to ${P}_{i , j}^{z} ,$
and Column C corresponds to ${ρ}_{i , j}^{a} .$
No.1-No.9
(x'O'z plane)

| A | B | C |
|---|---|---|
| −800.0 | −80.36 | 209.1 |
| −800.0 | −112.6 | 205.3 |
| −800.0 | −152.8 | 189.2 |
| −800.0 | −206.0 | 171.9 |
| −800.0 | −278.5 | 157.0 |
| −800.0 | −370.1 | 138.6 |
| −800.0 | −470.5 | 112.0 |
| −600.0 | −80.37 | 209.1 |
| −600.0 | −112.6 | 205.3 |
| −600.0 | −152.8 | 189.1 |
| −600.0 | −206.0 | 171.8 |
| −600.0 | −278.6 | 157.1 |
| −600.0 | −369.7 | 138.3 |
| −600.0 | −469.4 | 111.5 |
| −400.0 | −80.37 | 209.1 |
| −400.0 | −112.6 | 205.3 |
| −400.0 | −152.8 | 189.1 |
| −400.0 | −206.0 | 171.8 |
| −400.0 | −278.7 | 157.2 |
| −400.0 | −369.4 | 138.0 |
| −400.0 | −468.9 | 111.2 |
| −200.0 | −80.37 | 209.1 |
| −200.0 | −112.6 | 205.3 |
| −200.0 | −152.8 | 189.1 |
| −200.0 | −206.0 | 171.8 |
| −200.0 | −278.7 | 157.2 |
| −200.0 | −368.9 | 137.7 |
| −200.0 | −468.7 | 111.1 |
| 0.0 | −80.37 | 209.1 |
| 0.0 | −112.6 | 205.3 |
| 0.0 | −152.8 | 189.1 |
| 0.0 | −206.0 | 171.8 |
| 0.0 | −278.7 | 157.2 |
| 0.0 | −368.8 | 137.6 |
| 0.0 | −468.6 | 111.1 |
| 200.0 | −80.37 | 209.1 |
| 200.0 | −112.6 | 205.3 |
| 200.0 | −152.8 | 189.1 |
| 200.0 | −206.0 | 171.8 |
| 200.0 | −278.7 | 157.2 |
| 200.0 | −368.9 | 137.7 |
| 200.0 | −468.7 | 111.1 |
| 400.0 | −80.37 | 209.1 |
| 400.0 | −112.6 | 205.3 |
| 400.0 | −152.8 | 189.1 |
| 400.0 | −206.0 | 171.8 |
| 400.0 | −278.7 | 157.2 |
| 400.0 | −369.4 | 138.0 |
| 400.0 | −468.9 | 111.2 |
| 600.0 | −80.37 | 209.1 |
| 600.0 | −112.6 | 205.3 |
| 600.0 | −152.8 | 189.1 |
| 600.0 | −206.0 | 171.8 |
| 600.0 | −278.6 | 157.1 |
| 600.0 | −369.7 | 138.3 |
| 600.0 | −469.7 | 111.5 |
| 800.0 | −80.36 | 209.1 |
| 800.0 | −112.6 | 205.3 |
| 800.0 | −152.8 | 189.2 |
| 800.0 | −206.0 | 171.9 |
| 800.0 | −278.5 | 157.0 |
| 800.0 | −370.1 | 138.6 |
| 800.0 | −470.5 | 112.0 |

No.1-Source

| A | B | C |
|---|---|---|
| 2154. | −80.36 | 209.1 |
| 2154. | −112.6 | 205.3 |
| 2154. | −152.8 | 189.2 |
| 2154. | −206.0 | 171.9 |
| 2154. | −278.5 | 157.0 |
| 2154. | −370.1 | 138.6 |
| 2154. | −470.5 | 112.0 |
| 1826. | −502.0 | 88.66 |
| 1219. | −434.9 | 74.70 |
| 705.3 | −337.6 | 67.22 |
| 322.0 | −209.7 | 62.22 |
| 68.07 | −60.41 | 57.77 |
| 190.4 | −95.23 | 54.12 |
| 437.7 | −218.8 | 52.05 |
| 621.3 | −310.6 | 51.22 |
| 753.9 | −376.9 | 50.96 |

No.2-Source

| A | B | C |
|---|---|---|
| 2088 | −80.37 | 209.1 |
| 2088 | −112.6 | 205.3 |
| 2088 | −152.8 | 189.1 |
| 2088 | −206.0 | 171.8 |
| 2088 | −278.6 | 157.1 |
| 2088 | −369.7 | 138.3 |
| 2088 | −469.4 | 111.5 |
| 1689. | −479.4 | 88.85 |
| 1117. | −412.1 | 75.03 |
| 640.5 | −316.1 | 67.15 |
| 286.8 | −191.7 | 61.61 |
| 51.05 | −46.44 | 57.04 |
| 209.0 | −104.5 | 53.88 |
| 445.1 | −222.5 | 52.36 |
| 618.2 | −309.1 | 51.80 |
| 742.4 | −371.2 | 51.64 |

No.3-Source

| A | B | C |
|---|---|---|
| 2040. | −80.37 | 209.1 |
| 2040. | −112.6 | 205.3 |
| 2040. | −152.8 | 189.1 |
| 2040. | −206.0 | 171.8 |
| 2040. | −278.7 | 157.2 |
| 2040. | −369.4 | 138.0 |
| 2040. | −468.9 | 111.2 |
| 1592. | −463.1 | 88.99 |
| 1046. | −395.5 | 75.23 |
| 595.8 | −300.6 | 67.02 |
| 262.2 | −178.7 | 61.16 |
| 38.61 | −35.84 | 56.67 |
| 222.8 | −111.4 | 53.85 |
| 449.6 | −224.8 | 52.60 |
| 615.0 | −307.5 | 52.17 |
| 733.3 | −366.6 | 52.05 |

No.4-Source

| A | B | C |
|---|---|---|
| 2010. | −80.37 | 209.1 |
| 2010. | −112.6 | 205.3 |
| 2010. | −152.8 | 189.1 |
| 2010. | −206.0 | 171.8 |
| 2010. | −278.7 | 157.2 |
| 2010. | −368.9 | 137.7 |
| 2010. | −468.7 | 111.1 |
| 1533. | −452.8 | 89.08 |
| 1003. | −385.3 | 75.32 |
| 568.8 | −291.1 | 66.92 |
| 246.9 | −170.5 | 60.93 |
| 30.99 | −29.14 | 56.47 |
| 231.1 | −115.5 | 53.87 |
| 452.1 | −226.0 | 52.76 |
| 612.7 | −306.3 | 52.40 |
| 727.3 | −363.6 | 52.29 |

No.5-Source

| A | B | C |
|---|---|---|
| 2000. | −80.37 | 209.1 |
| 2000. | −112.6 | 205.3 |
| 2000. | −152.8 | 189.1 |
| 2000. | −206.0 | 171.8 |
| 2000. | −278.7 | 157.2 |
| 2000. | −368.8 | 137.6 |
| 2000. | −468.6 | 111.1 |
| 1514. | −449.4 | 89.11 |
| 989.5 | −381.9 | 75.35 |
| 559.6 | −287.8 | 66.93 |
| 241.9 | −167.8 | 60.85 |
| 28.46 | −26.88 | 56.41 |
| 233.9 | −116.9 | 53.88 |
| 452.9 | −226.4 | 52.82 |
| 611.8 | −305.9 | 52.47 |
| 725.2 | −362.6 | 52.37 |

No.6-Source

| A | B | C |
|---|---|---|
| 2010. | −80.37 | 209.1 |
| 2010. | −112.6 | 205.3 |
| 2010. | −152.8 | 189.1 |
| 2010. | −206.0 | 171.8 |
| 2010. | −278.7 | 157.2 |
| 2010. | −368.9 | 137.7 |
| 2010. | −468.7 | 111.1 |
| 1533. | −452.8 | 89.08 |
| 1003. | −385.3 | 75.32 |
| 568.8 | −291.1 | 66.92 |
| 246.9 | −170.5 | 60.93 |
| 30.99 | −29.14 | 56.47 |
| 231.1 | −115.5 | 53.87 |
| 452.1 | −226.0 | 52.76 |
| 612.7 | −306.3 | 52.40 |
| 727.3 | −363.6 | 52.29 |

No.7-Source

| A | B | C |
|---|---|---|
| 2040. | −80.37 | 209.1 |
| 2040. | −112.6 | 205.3 |
| 2040. | −152.8 | 189.1 |
| 2040. | −206.0 | 171.8 |
| 2040. | −278.7 | 157.2 |
| 2040. | −369.4 | 138.0 |
| 2040. | −468.9 | 111.2 |
| 1592. | −463.1 | 88.99 |
| 1046. | −395.5 | 75.23 |
| 595.8 | −300.6 | 67.02 |
| 262.2 | −178.7 | 61.16 |
| 38.61 | −35.84 | 56.67 |
| 222.8 | −111.4 | 53.85 |
| 449.6 | −224.8 | 52.60 |
| 615.0 | −307.5 | 52.17 |
| 733.3 | −366.6 | 52.05 |

No.8-Source

| A | B | C |
|---|---|---|
| 2088 | −80.37 | 209.1 |
| 2088 | −112.6 | 205.3 |
| 2088 | −152.8 | 189.1 |
| 2088 | −206.0 | 171.8 |
| 2088 | −278.6 | 157.1 |
| 2088 | −369.7 | 138.3 |
| 2088 | −469.4 | 111.5 |
| 1689. | −479.4 | 88.85 |
| 1117. | −412.1 | 75.03 |
| 640.5 | −316.1 | 67.15 |
| 286.8 | −191.7 | 61.61 |
| 51.05 | −46.44 | 57.04 |
| 209.0 | −104.5 | 53.88 |
| 445.1 | −222.5 | 52.36 |
| 618.2 | −309.1 | 51.80 |
| 742.4 | −371.2 | 51.64 |

No.9-Source

| A | B | C |
|---|---|---|
| 2154. | −80.36 | 209.1 |
| 2154. | −112.6 | 205.3 |
| 2154. | −152.8 | 189.2 |
| 2154. | −206.0 | 171.9 |
| 2154. | −278.5 | 157.0 |
| 2154. | −370.1 | 138.6 |
| 2154. | −470.5 | 112.0 |
| 1826. | −502.0 | 88.66 |
| 1219. | −434.9 | 74.70 |
| 705.3 | −337.6 | 67.22 |
| 322.0 | −209.7 | 62.22 |
| 68.07 | −60.41 | 57.77 |
| 190.4 | −95.23 | 54.12 |
| 437.7 | −218.8 | 52.05 |
| 621.3 | −310.6 | 51.22 |
| 753.9 | −376.9 | 50.96 |

In addition, the offset of the axial configuration is at least 5 times the total thickness of a detection stratum. The offset of the equatorial configuration is at least 4 times the total thickness of the detection stratum. The detection depth

$${δ}_{i , j}^{FD}$$

can further be obtained from other improved algorithms.

The above method is also applicable to other sources and other configurations in the CSAMT, provided that the definition of the apparent resistivity used is still associated with the earth resistivity in the near-field zone.

The critical value of field zone cri^{far-tran} and the critical value of field zone cri^{tran-near} can be adjusted according to geological structure, configuration, source or observation component.

Field observation records further include a position of the source besides the position of the observation point and a scale of the source, to determine the offset.

In conclusion, the generation method of an all-zone apparent resistivity-depth section for CSAMT provided by the present disclosure expands the recording point from the observation point to the position adjacent to the source according to the induction number, and gives equations for calculating the recording point in the far-field zone, the transition-field zone and the near-field zone, thereby providing a novel simple and quick method to analytically separate the planewave and the nonplanewave, and to eliminate and utilize the source overprint effect and the shadow effect.

The above examples are only used to illustrate the design ideas and features of the present disclosure, such that those skilled in the art can understand and implement the content of the present disclosure accordingly; and the protection scope of the present disclosure is not limited to the above examples. Therefore, all equivalent changes or modifications made according to the principle and design idea disclosed in the present disclosure fall within the protection scope of the present disclosure.

1. A generation method of an all-zone apparent resistivity-depth section for controlled source audio-frequency magneto-telluric (CSAMT), comprising: taking a horizontal position
$${P}_{i , j}^{r}$$
and a vertical position
$${P}_{i , j}^{z}$$
of a recording point as an assignment point for an apparent resistivity, wherein in a far-field zone, the recording point is located at a detection depth under an observation point; in a transition-field zone, a radius of a wavefront decreases linearly with a decrease of an induction number, and the recording point is located at an intersection between the wavefront and a straight line from the detection depth to a source, and approaches to the source from the observation point with the decrease of the induction number; and in a near-field zone, with a continuous decrease of the induction number, the horizontal position of the recording point approaches from a position adjacent to the source to a midpoint of an offset, and the vertical position of the recording point approaches from a position adjacent to and under the source to a fixed value:
$$\begin{matrix}{P}_{i , j}^{r} = {r}_{i} \\ {P}_{i , j}^{z} = - {δ}_{i , j}^{FD}\end{matrix} \} , {B}_{i , j} \geq {cri}^{far - tran} \qquad ( 1 a )$$
$$\begin{matrix}{P}_{i , j}^{r} = \frac{{B}_{i , j}}{\sqrt{{B}_{i , j}^{2} + 1}} \frac{{r}_{i}}{{cri}^{far - tran} - {cri}^{tran - near}} ( {B}_{i , j} - {cri}^{tran - near} ) \\ {P}_{i , j}^{z} = - \frac{1}{\sqrt{{B}_{i , j}^{2} + 1}} \frac{{r}_{i}}{{cri}^{far - tran} - {cri}^{tran - near}} ( {B}_{i , j} - {cri}^{tran - near} )\end{matrix} \} , \qquad ( 1 b )$$
$${cri}^{tran - near} < {B}_{i , j} < {cri}^{far - tran}$$
$$\begin{matrix}{P}_{i , j}^{r} = \frac{{r}_{i}}{2} ( \frac{{cri}^{tran - near} - {B}_{i , j}}{{cri}^{tran - near}} ) \\ {P}_{i , j}^{z} = - \frac{{r}_{i}}{{cri}^{far - tran}} ( \frac{{cri}^{tran - near} - {B}_{i , j}}{{cri}^{tran - near}} )\end{matrix} \} , 0 < {B}_{i , j} < {cri}^{tran - near} \qquad ( 1 c )$$
wherein,
$${B}_{i , j} = \frac{{r}_{i}}{{δ}_{i , j}^{FD}}$$
is the induction number, rᵢ is an offset detection depth,
$${δ}_{i , j}^{FD}$$
is the detection depth, i=1, 2, . . . , m is a serial number of the observation point, j=1, 2, . . . , n is a serial number of a frequency point, cri^{far-tran} is a critical value between the far-field zone and the transition-field zone, and cri^{tran-near} is a critical value between the transition-field zone and the near-field zone;
(1) for an axial configuration, assuming that the source coincides with an origin O of a rectangular coordinate system, and a survey line is arranged along an x-axis, if a superscript r of
$${P}_{i , j}^{r}$$
in each of the Equation (1a), the Equation (1b), and the Equation (1c) is replaced with x, then on an xOz plane along a direction of the survey line, the recording point for each observation point has the horizontal position labeled as
$${P}_{i , j}^{x} ,$$
and the vertical position labeled as
$${P}_{i , j}^{z} ,$$
and a position is the assignment point for the apparent resistivity
$${ρ}_{i , j}^{a}$$
of each observation point of the axial configuration on the xOz plane; and one survey line of the axial configuration generates one apparent resistivity-depth section along the direction of the survey line;
(2) for an equatorial configuration, one equatorial configuration having m observation points generates one section along a survey line, and m sections from the source to the observation points; assuming that a midpoint of the survey line serves an origin O′, the source coincides with an origin O of a cylindrical coordinate system, a connecting line OO′ is perpendicular to the survey line, and the direction of the survey line is set as an x′-axis of a rectangular coordinate system, if the superscript r of the
$${P}_{i , j}^{r}$$
in the Equation (1a) is replaced with x′, then on an x′O′z plane along the direction of the survey line, the recording point for each observation point has the horizontal position labeled as
$${P}_{i , j}^{{x}^{′}} ,$$
and a position of the recording
$${P}_{i , j}^{z} ,$$
and the vertical position labeled as point is the assignment point for the apparent resistivity
$${ρ}_{i , j}^{a}$$
of each observation point of the equatorial configuration on the x′O′z plane; and
on each rOz plane where each section from the source to the observation point is located, the horizontal position
$${P}_{i , j}^{r}$$
and the vertical position
$${P}_{i , j}^{z}$$
of the recording point for each observation point are still as shown in the Equation (1a), the Equation (1b), and the Equation (1c); and a position of the recording point is the assignment point for the apparent resistivity
$${ρ}_{i , j}^{a}$$
of each observation point of the equatorial configuration on the rOz plane.

2. The generation method of the all-zone apparent resistivity-depth section for the CSAMT according to claim 1, wherein the fixed value is proportional to the offset; and expressed as the fixed value is equal to the offset rᵢ divided by the critical value cri^{far-tran} between the far-field zone and the transition-field zone.

3. The generation method of the all-zone apparent resistivity-depth section for the CSAMT according to claim 1, wherein a relationship between the offset rᵢ and the position
$${x}_{i}^{′}$$
or the observation point in the equatorial configuration is expressed as:
$${r}_{i} = \sqrt{O {O}^{′ 2} + {x}_{i}^{′ 2}} \qquad ( 2 )$$
wherein, the survey line is arranged along the x′-axis of the rectangular coordinate system, the midpoint of the survey line serves as the origin O′, the source coincides with the origin O of the cylindrical coordinate system, the connecting line is OO′, and
$${x}_{i}^{′}$$
is a value of the observation point on the x′-axis.

4. The generation method of the all-zone apparent resistivity-depth section for the CSAMT according to claim 1, wherein the apparent resistivity
$${ρ}_{i , j}^{a}$$
is defined and calculated from an all-zone expression of a single-component electric field or a single-component magnetic field; and an all-zone expression of a component of an electric field
$${E}_{i , j}^{x}$$
and a simple iterative expression for an all-zone apparent resistivity are:
$${E}_{i , j}^{x} = \frac{{I}_{j} l {ρ}_{i , j}^{a}}{4 π {r}^{3} ,} [ 2 {e}^{- {jk}_{i , j} {r}_{i}} ( 1 + {jk}_{i , j} {r}_{i} ) + 3 cos 2 {φ}_{i} - 1 ] \qquad ( 3 a )$$
$${ρ}_{i , j}^{a} = \frac{4 π {r}_{i}^{3}}{{I}_{j} l} \vert \frac{{E}_{i , j}^{x}}{2 {e}^{- {jk}_{i , j} {r}_{i}} ( 1 + {jk}_{i , j} {r}_{i} ) + 3 cos 2 {φ}_{i} - 1} \vert \qquad ( 3 b )$$
the all-zone expression of the electric field
$${E}_{i , j}^{y}$$
and a direct calculation expression for the all-zone apparent resistivity are:
$${E}_{i , j}^{y} = \frac{3 {I}_{j} l {ρ}_{i , j}^{a}}{4 π {r}_{i}^{3}} sin 2 {φ}_{i} \qquad ( 4 a )$$
$${ρ}_{i , j}^{a} = \frac{4 π {r}_{i}^{3}}{3 {l}_{j} l} \vert \frac{{E}_{i , j}^{y}}{sin 2 {φ}_{i}} \vert \qquad ( 4 b )$$
wherein, Iⱼ is a source current intensity of a j th frequency point, l is a length of the source, j is an imaginary unit, φᵢ is an included angle between the observation point i and the source, and
$${k}_{i , j} = \frac{2 π}{{10}^{3}} \sqrt{- j \frac{{f}_{i , j}}{{ρ}_{i , j}^{a}} / 5} ,$$
wherein f_{i,j} being a frequency of the j th frequency point of the observation point i, and μ₀ being a permeability of a nonmagnetic earth.

5. The generation method of the all-zone apparent resistivity-depth section for the CSAMT according to claim 1, wherein the detection depth
$${δ}_{i , j}^{FD}$$
is calculated by a skin depth equation:
$${δ}_{i , j}^{FD} \approx 503 \sqrt{\frac{{ρ}_{i , j}^{a}}{{f}_{i , j}}} \qquad ( 5 )$$
wherein, f_{i,j} is a frequency of a j th frequency point of the observation point i, and
$${ρ}_{i , j}^{a}$$
is the apparent resistivity of the J th frequency point of the observation point i.

6. The generation method of the all-zone apparent resistivity-depth section for the CSAMT according to claim 1, wherein the offset is at least cri^{far-tran} times a total thickness of a detection stratum.

7. The generation method of the all-zone apparent resistivity-depth section for the CSAMT according to claim 1, wherein for the axial configuration, the critical values cri^{far-tran} and cri^{tran-near} of filed zones are respectively selected as 5 and 1.

8. The generation method of the all-zone apparent resistivity-depth section for the CSAMT according to claim 1, wherein for the equatorial configuration, the critical values cri^{far-tran} and cri^{tran-near} of filed zones are respectively selected as 4 and 1.

9. The generation method of the all-zone apparent resistivity-depth section for the CSAMT according to claim 1, wherein the critical values cri^{far-tran} and cri^{tran-near} of filed zones are adjusted according to geological structure, configuration, source, or observation component.

10. The generation method of the all-zone apparent resistivity-depth section for the CSAMT according to claim 1, wherein field observation records further comprise a position of the source besides the position of the observation point and a scale of the source, to determine the offset.
